(19) United States
(12) Patent Application Publication
(10) Pub. No.: US 2026/0052377 A1
(43) Pub. Date: Feb. 19, 2026

(54) METHODS AND APPARATUS FOR UE CAPABILITY REPORTING

(71) Applicant: APPLE INC., Cupertino, CA (US)

(72) Inventors: Fangli Xu, Beijing (CN); Peng Cheng, Beijing (CN); Haitong Sun, Cupertino, CA (US); Srirang A. Lovlekar, Fremont, CA (US); Shu Guo, Beijing (CN); Naveen Kumar R. Palle Venkata, San Diego, CA (US); Sethuraman Gurumoorthy, San Ramon, CA (US); Yuqin Chen, Beijing (CN); Haijing Hu, Los Gatos, CA (US); Ralf Rossbach, Munich (DE)

(21) Appl. No.: 18/934,630

(22) Filed: Nov. 1, 2024

Related U.S. Application Data
(60) Provisional application No. 63/684,174, filed on Aug. 16, 2024.

(51) Int. Cl. H04W 8/24

(52) U.S. Cl. CPC H04W 8/24

(57) ABSTRACT

Methods, systems, and apparatuses for consideration of user equipment (UE) capabilities are discussed herein. In some embodiments, a UE may receive a UE capability enquiry requesting information about capabilities of the UE. The UE may send a UE capability report indicating one or more capability sets that the UE supports. The UE may receive a configuration based on the UE capability report.

### TECHNICAL FIELD

This application relates generally to wireless communication systems, including reporting user equipment (UE) capabilities.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrate an example of a UE capability structure in accordance with some embodiments.

FIG. 1B illustrate an example of a UE capability structure in accordance with some embodiments.

FIG. 2 illustrates an example of UE capability transfer in accordance with some embodiments.

FIG. 3A illustrates a UE-NR-Capability report in accordance with some embodiments.

FIG. 3B illustrates an example UE capability information report in accordance with some embodiments.

FIG. 3C illustrates an example UE capability enquiry that may be sent from the network node to the UE in accordance with some embodiments.

FIG. 3D illustrates an example table of a capability request filter in accordance with some embodiments.

FIG. 3E illustrates an example of the information that may be included in the frequency band list in accordance with some embodiments.

FIG. 4A illustrates an example signal diagram of a capability enquiry procedure with RRC segmentation for UE capability transmission in accordance with some embodiments.

FIG. 4B illustrates an example of an RRC capability segmentation procedure in accordance with some embodiments.

FIG. 4C illustrates an example of a processing time definition in accordance with some embodiments.

FIG. 5A illustrates an example signal diagram of UE capability transfer using scheme 2 in accordance with some embodiments.

FIG. 5B illustrates a UE capability retrieval from UCMF procedure in accordance with some embodiments.

FIG. 6 illustrates an example of a UE Capability ID structure in accordance with some embodiments.

FIG. 7 illustrates an example of UCMF architecture and related reference points in 5GS and EPS in accordance with some embodiments.

FIG. 8 illustrates an example of a UE radio Capability ID mapping procedure in accordance with some embodiments.

FIG. 9 illustrates an example table that may be used by the UE and the network to define UE category indicators in accordance with some embodiments.

FIG. 10 illustrates two example UE capability structures that a UE may use to report the capability sets in accordance with some embodiments.

FIG. 11 illustrates an example signal flow diagram of a UE capability request and report procedure with multiple capability sets, according to embodiments herein.

FIG. 12 illustrates an example signal flow diagram of a dynamic change between the capability sets stored in network side in accordance with some embodiments.

FIG. 13 illustrates an example signal flow diagram where the UE reports the capability based on the current connection for a dynamic capability change in accordance with some embodiments.

FIG. 14 illustrates a signal flow diagram where the UE reports the capability based on the activated configuration via network L1/L2 control for a dynamic capability change, according to embodiments herein.

FIG. 15 illustrates an example signal flow diagram using a UE capability ID mechanism, according to embodiments herein.

FIG. 16 illustrates an example signal flow diagram using a UE capability ID mechanism based on slices, according to embodiments herein.

FIG. 17 illustrates an example signal flow diagram for UE capability retrieval, according to embodiments herein.

FIG. 18 illustrates a signal flow diagram for UE capability retrieval, according to embodiments herein.

FIG. 19 illustrates a signal flow diagram where the UE informs network about the capability change using a UE capability ID mechanism in accordance with some embodiments.

FIG. 20 illustrates a signal flow diagram for a two-step UE capability report (e.g., level-1 capability and level-2 capability), according to embodiments herein.

FIG. 21 illustrates a method performed by a UE, according to embodiments herein.

FIG. 22 illustrates a method performed by a network node, according to embodiments herein.

FIG. 23 illustrates an example architecture of a wireless communication system, according to embodiments disclosed herein.

FIG. 24 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In New Radio (NR), a flexible User Equipment (UE) capability structure is designed to improve adaptability and efficiency by decoupling the band combination (BC) and feature set (FS) (baseband processing capability).

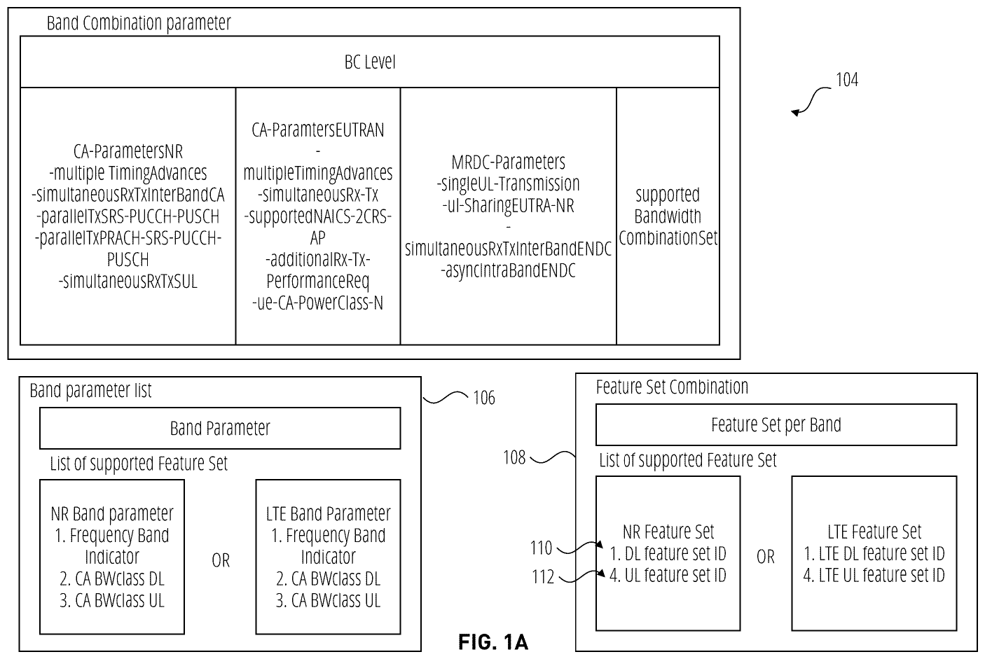

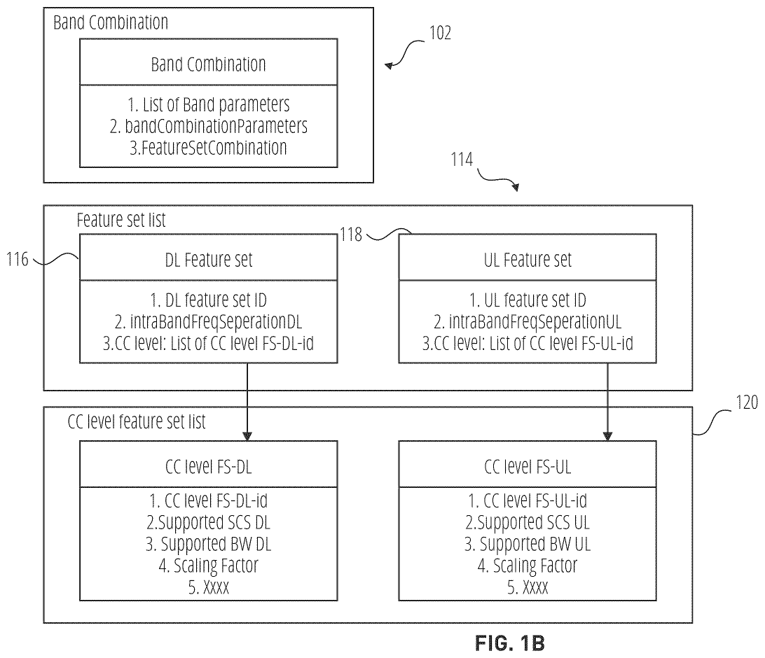

FIG. 1A and FIG. 1B illustrate an example of a UE capability structure. The Band combination structure 102 may include a List of Band parameters (e.g., band combination parameter 104), band combination parameters (e.g., band parameter list 106), and a feature set combination (e.g., feature set combination 108). The feature set combination 108 may include a downlink feature set ID 110 and an uplink feature set ID 112 that may indicate a downlink feature set 116 and an uplink feature set 118 of a feature set list 114. The downlink feature set 116 and the uplink feature set 118 may indicate a component carrier level feature set list 120.

For the band combination structure 102 a fallback rule may be employed for NR that corresponds to the fallback rule of LTE. The fallback rule for the band combination structure may refer to a mechanism used by networks to handle cases where a UE does not support the full band combination capabilities required by the network for a particular service. If the network requests a specific band combination that the UE cannot support, the UE can fall back to a more basic or less demanding configuration that it can support.

In the context of band combination in wireless networks, decoupling downlink and uplink bands can refer to separating the way downlink and uplink bands are defined in carrier aggregation setups. This may allow for more flexibility in how the UE reports its capabilities and how the network can configure different band combinations for downlink and uplink. Two combinations for decoupling downlink and uplink bands may include the following. In a first option, possible uplink combinations may be included in downlink combinations. For example, the UE may list possible uplink combinations for each downlink combination. In a second option, the index of uplink combinations may be provided from downlink combination. For example, for each downlink combination, the UE may provide an index that refers to a predefined set of UL combinations.

A Band, Parameter, and Component (BPC) structure (e.g., feature set combination 108 may define UE capabilities in terms of supported features, frequencies, and component carriers. This structure may allow for efficient signaling and flexibility in defining different combinations of bands, feature sets, and component carrier configurations. In some embodiments, the feature set combination 108 may indicate a feature set per band parameter. For example, the supported feature set may be specified for one or more frequency bands. In some embodiments, the feature set combination 108 may indicate a feature set per component carrier. For example, the supported feature set may be specified for one or more component carriers.

In some embodiments, the capability reported by the UE may be based on a network request. The request for band combinations may be based on band information.

Capability parameters may include optional features and mandatory features. The optional features may include a capability parameter that indicates whether the feature has been implemented and successfully tested. For example, for optional features, the UE radio access capability parameter may indicate whether the feature has been implemented and successfully tested.

In some embodiments, the mandatory features may be used without a capability parameter. For example, fundamental functionality may be used with a capability parameter. In some embodiments, a mandatory feature may be used with a capability parameter. For example, the capability parameters may be for features that are mandatory but have an ability to indicate successful IOT. As provided in the 3GPP TS: the capability parameter and/or mandatory feature may be mandatory for UEs of some releases of the specification.

In some cases, there may be no UE category. The UE category may not be applicable for NR and E-UTRAN New Radio-Dual Connectivity (EN-DC). Multiple Input, Multiple Output (MIMO), modulation schemes may be signaled explicitly in UE capability.

How to calculate UE max data rate may be based on UE's band combinations together with the baseband capabilities (modulation scheme, MIMO layers, . . . ). UE's band combinations together with the baseband capabilities may comprise all information necessary to calculate the maximum data rate achievable on each serving cell, in each cell group and per UE.

Table 1 includes an example list of features for a UE.

TABLE 1

| | Feature List |
|---|---|
| MAC | RA procedure on PCell |
| | RA procedure on PSCell for EN-DC* |
| | UE initiated RA procedure |
| | UE initiated RA procedure for beam recovery |
| | NW initiated RA procedure (i.e. based on PDCCH) |
| | Support of ssb-Threshold and association between |
| | preambles/PRACH occasion and SS block |
| | Preamble grouping |
| | UL single TA maintenance |
| | UL multiple TA maintenance for EN-DC* |
| | HARQ operation for DL and UL |
| | LCH prioritization |
| | Prioritized bit rate |
| | Multiplexing |
| | SR with single SR configuration |
| | BSR |
| | PHR |
| | 8 bits L field |
| | 16 bits L field |
| | *Note1: If EN-DC is supported |
| RLC | RLC TM |
| | RLC AM(with 18 bits SN)* |
| | SDU discard |
| | Note1: No separate feature is considered on t-PollRetransmit, |
| | t-Reassembly and t-StatusProhibit |
| PDCP | (de)Ciphering on SRB |
| | Integrity protection on SRB |
| | Timer based SDU discard |
| | Re-ordering and in-order delivery |
| | Status reporting |
| | Duplicate discarding |
| | 18 bits SN |
| EN-DC | MCG DRB (with LTE PDCP) |
| Procedure | Joint processing on the combined RRC messages |
| | SN addition, modification and release via RRC connection |
| | reconfiguration |
| | Failure handling (including both MN and SN) |
| | MCG DRB (with NR PDCP) |
| | SCH DRB (with NR PDCP) |

In some examples, different UE capabilities may be introduced to support the different features/UE devices (e.g., Reduced Capability (RedCap), IIOT, extended reality (XR), vehicle-to-Everything (V2X), Integrated Access and Backhaul (IAB), Multicast-Broadcast Service (MBS)).

The capability request and report procedure may be a unified procedure to cover all features. In some embodiments, the capability request and report are for UE to report all UE supported capabilities regardless of the specific feature/device type. In some embodiments, no specific indication in the capability request message to request the capability related to some special features/UE devices. When the UE receives the request, UE may report all the supported capabilities based on the request band information. Unified capability related request and report procedure may also be considered. Capabilities for different features/UE devices may be designed to be in the same level.

Various capabilities are provided in, for example 3GPP technical specification (TS) 38.822 Section 5.1.4 NR_IIOT (e.g., Table 5.1.4-1: Layer-1 feature lister for NR_IIOT), Section 5.1.12 NR_IAB (e.g., Table 5.1.12-1: Layer-1 feature list for NR_IAB) and Section 5.2.1 NR_IAB-Core (e.g., Table 5.2.1-1: Layer-2 and Layer-3 feature list for NR_IAB-Core).

Three different schemes for UE capability report and change procedure may be considered. In a first scheme (scheme 1), legacy UE Access Stratum (AS) capability is only changed via Non-Access Stratum (NAS) procedure. In this scheme, the UE AS capability is stored in Access and Mobility Management Function (AMF) (legacy). In some embodiments, the RAN node may acquire the UE capability from core network when UE enters CONNECTED state. The UE capability change may be only available via NAS TAU procedure.

In a second scheme (scheme 2), the legacy UE AS capability is only changed via NAS procedure (i.e., based on capability ID, in R16 RACS). The UE capability can be represented by a capability ID, which may be exchanged in NAS signaling over the air and in network signaling instead of the UE capability structure. The UE AS capability may be stored in user capability management function (UCMF) (for capability ID in radio access control subsystem (RACS)). The RAN node may acquire the UE capability from Access and Mobility Management Function (AMF)/UCMF when UE enters CONNECTED state. The UE capability change may be only via NAS TAU procedure (registration procedure, configuration update procedure).

In a third scheme (scheme 3), a Multiple Universal Subscriber Identity Module (MUSIM) temporary capability restriction may be used. The temporary capability may be only stored in the network node, not stored in the core network. Reporting temporary capability restriction information may be via UAI procedure. In UAI, the UE can indicate its temporary capability restriction information for the various types of UE capabilities including CA/DC capabilities, Maximum MIMO layer, Maximum channel bandwidth, Measurement gap requirement, the maximum component carrier (CC) numbers. The reporting of these changed capabilities can be used by the UE to request the release of the specific configurations (i.e., reactive approach), or to avoid receiving an unexpected configuration in the future (i.e. proactive approach). For the two cases (reactive and proactive), the content of the UAI and the UE behavior after sending the UAI are different. For the reactive approach, the network may be required to adjust the configuration according to it. If not, the UE may adjust the configuration based on its current capability directly.

In a proactive approach, the UE can indicate its forbidden and/or affected BC(s)/band(s) to the network. The forbidden BC(s)/band(s) means the UE does not prefer the network to configure these BC(s) or the band(s) to the UE. For the affected BCs/bands, the UE may additionally indicate the current maximum MIMO layer/bandwidth on these BCs/bands, which means the UE does not prefer the network to send the configuration that exceeds this maximum MIMO layer/bandwidth on these BCs or the bands. To reduce the signaling overhead, a network configured band-filter list and normal prohibit timer may be introduced for controlling the UE's reporting.

In a reactive approach, if the UE has constrained capability related to the current configuration, serving cell index can be used for setting the content of the UAI. The UE can indicate its preference on the release of specific serving cells, or indicate the temporary maximum MIMO layers/channel bandwidth for specific serving cells, the UE can also indicate its measurement gap requirement change due to dual active MUSIM operation. If the UE requests a change of capabilities reactively, the UE may be expected to receive a new RRC configuration from the network immediately. However, the network may still want to use the requested resource for transmission for a short time. As a compromise, a wait timer may be introduced for waiting the subsequent RRC reconfiguration. If the UE does not receive the reconfiguration that matches the UE's current capabilities indicated in the MUSIM UAI in a certain time, the UE may be allowed to switch its capabilities locally.

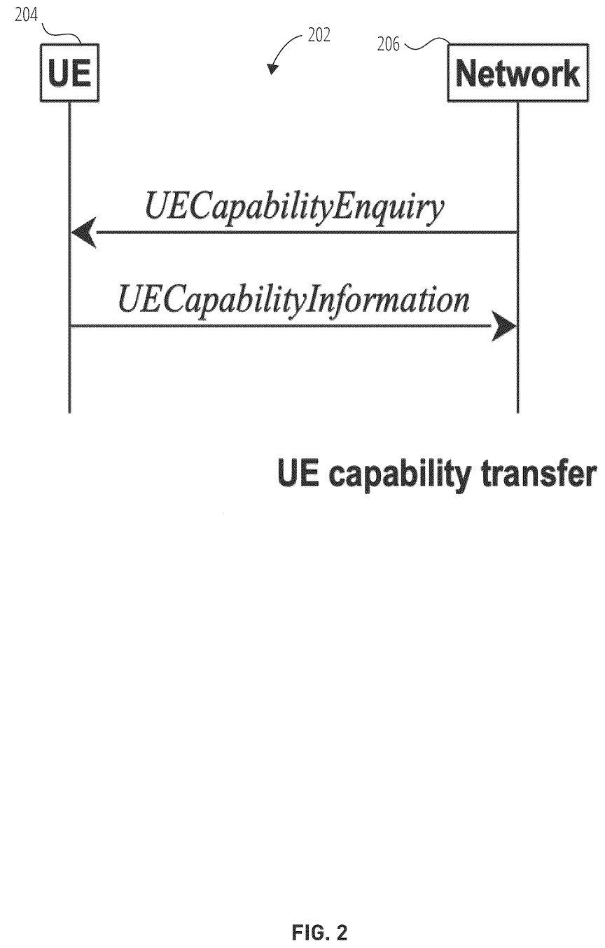

FIG. 2 illustrates an example signal diagram 202 of UE capability transfer using scheme 1 in accordance with some embodiments. In some wireless communication systems, the UE Radio Capability management may be at the network side with a capability provision from the AMF to the network node 206. If the AMF provides stored UE capability to the network node, the network node 206 may store it in the UE context till the UE connection release. There may further be capability information delivery from the network node to the AMF, where if the AMF does not provide the UE capability to the network node 206, the network node 206 may fetch the UE capability from UE 204 and forward it to AMF via a UE RADIO CAPABILITY INFO INDICATION message. In some cases, a capability check (i.e., Capability match procedure) may be performed where the AMF requests the network node 206 to derive and provide an indication to AMF on whether the UE capabilities are compatible with network configuration for IMS voice. Based on AMF request, network node may check the IMS related config and provide support indication to AMF.

If the network node 206 cannot acquire UE capability from core network, the network node 206 may enquire the UE 204 to provide the capability via AS RRC procedure. The network node 206 may initiate the procedure to a UE 204 in RRC_CONNECTED via RRC UE Capability Retrieval Procedure. The UE 204 may report its UE radio access capabilities which are static at least when the network requests. The network node 206 can provide the filter (e.g., RAT-Type, request band info) to help UE 204 to report the capability based on it.

In some examples, RRC segmentation for the UE capability transmission may be performed. To help report the huge size of RRC UE capability information, the network can enable segmentation. The UE 204 may perform RRC level segmentation transmission to the network.

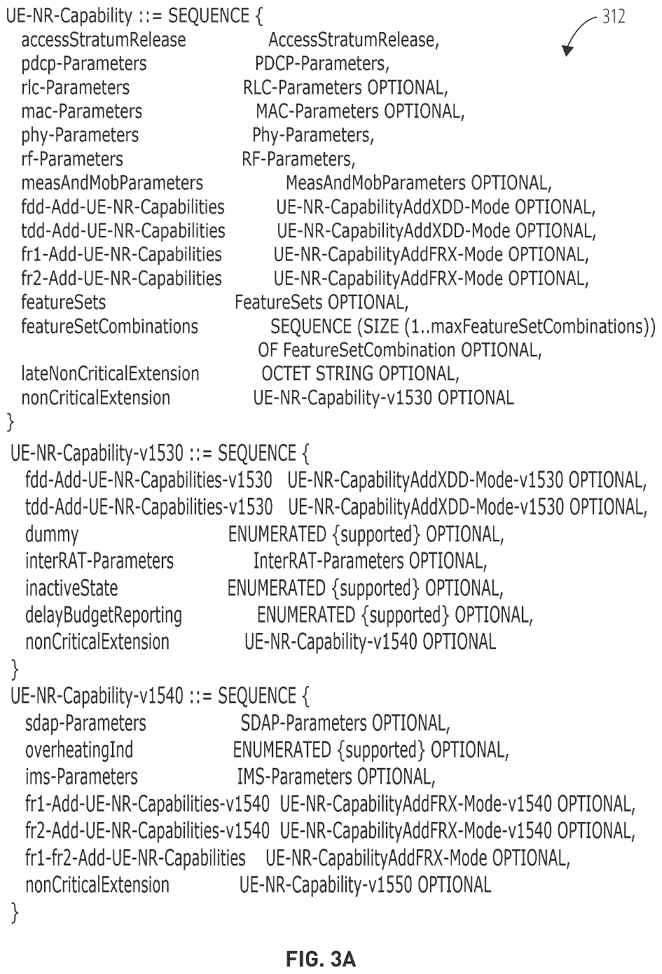

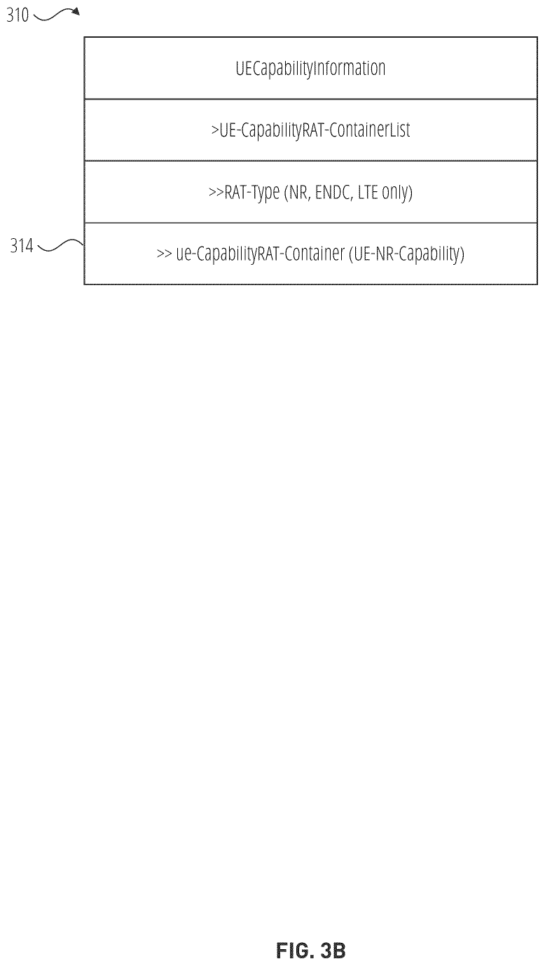

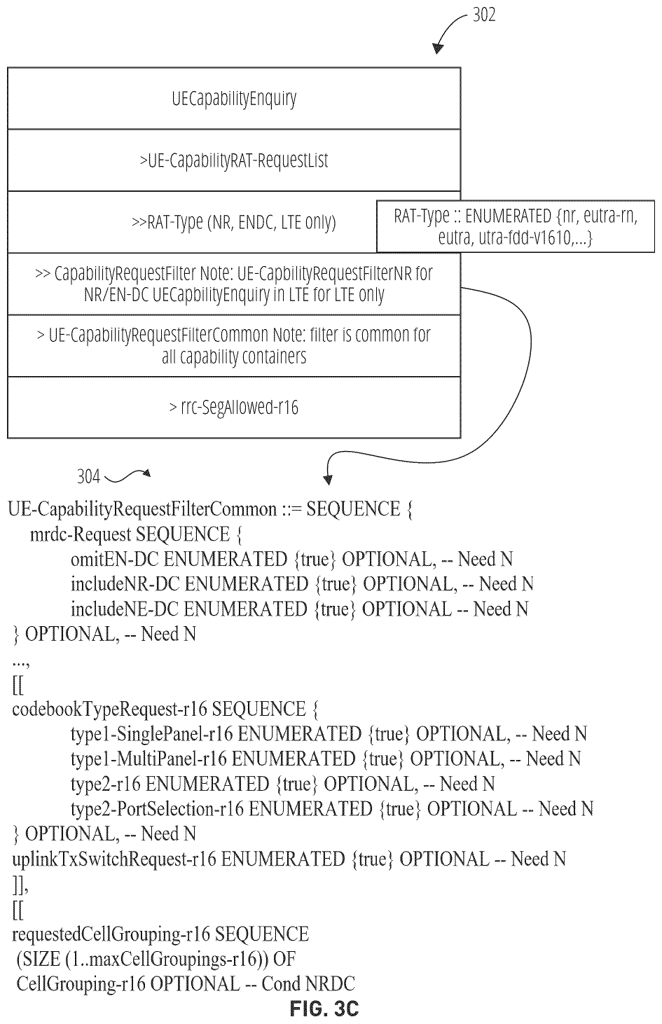

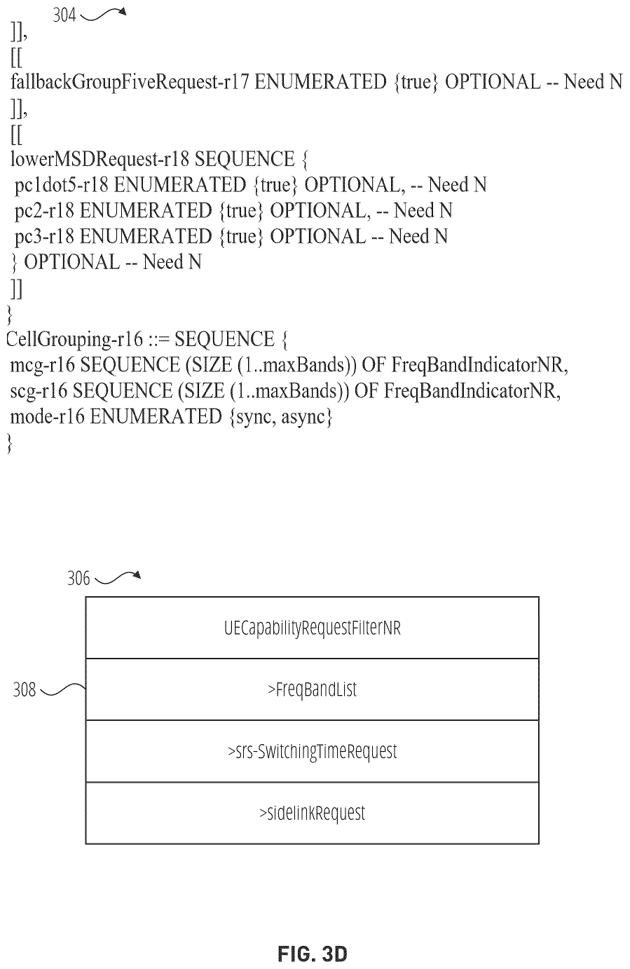

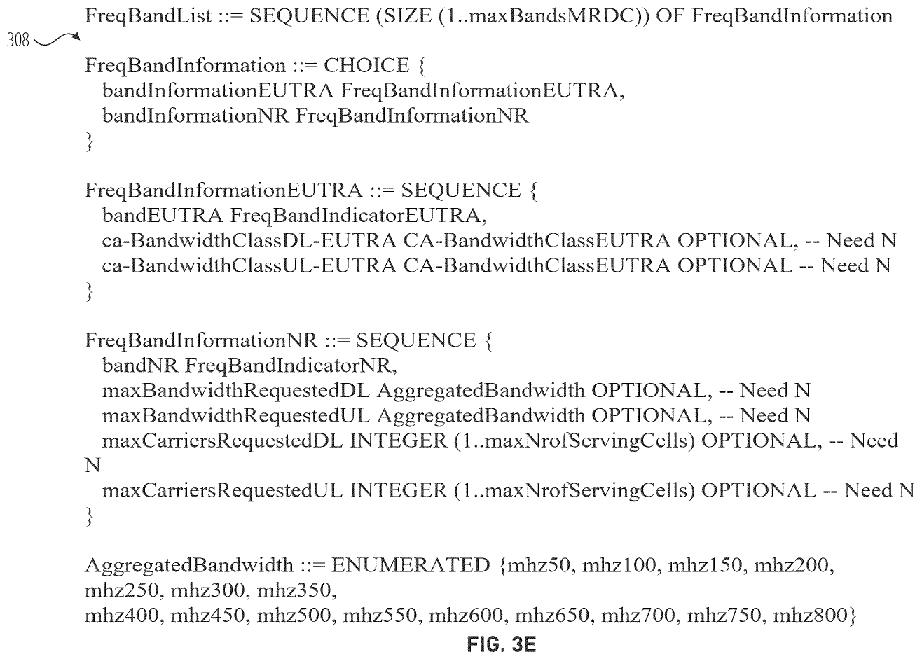

FIG. 3A, FIG. 3B, FIG. 3C, FIG. 3D, and FIG. 3E illustrate example information that may be sent and received during the UE capability transfer using scheme 1 shown in FIG. 2. Specifically, FIG. 3C illustrates an example UE capability enquiry 302 that may be sent from the network node 206 to the UE 204. As shown, the UE capability enquiry 302 may include a capability request filter 304. FIG. 3D illustrates an example table 306 of a capability request filter, and a continuation of the information that may be included in the capability request filter 304. The capability request filter 304 may include a frequency band list 308. FIG. 3E illustrates an example of the information that may be included in the frequency band list 308.

FIG. 3B illustrates an example UE capability information 310 that may be sent from the UE 204 to the network node 206 in response to the UE capability enquiry 302 in accordance with some embodiments. The UE capability information 310 may include a UE capability RAT-container 314 that includes a UE-NR-Capability 312 as shown in FIG. 3A.

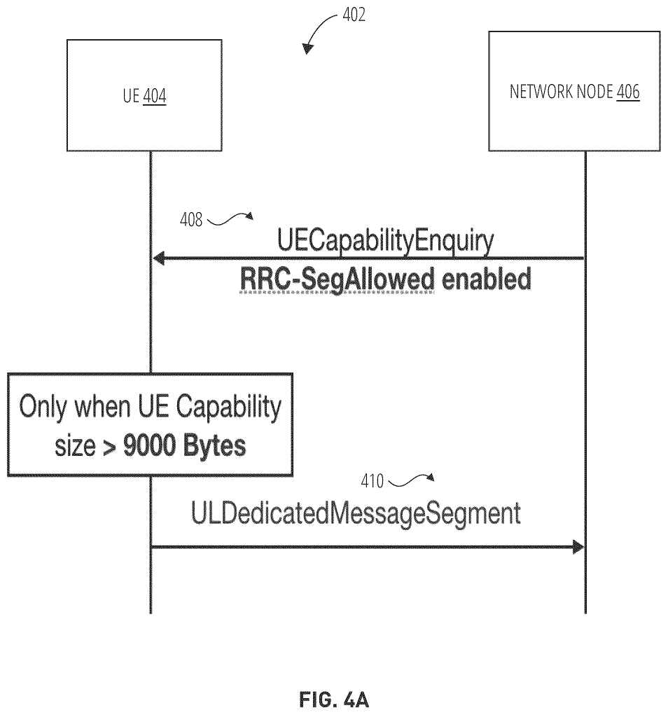

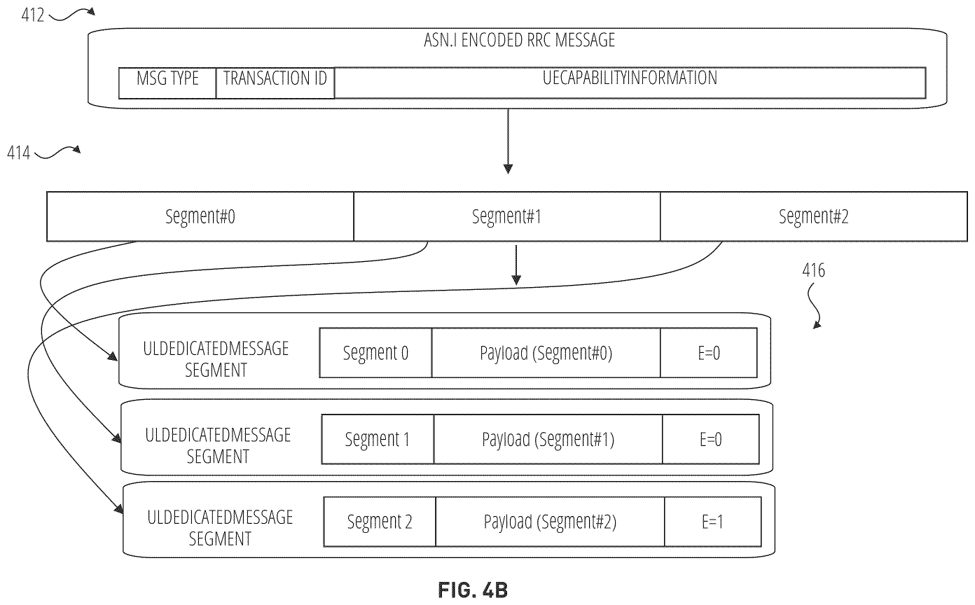

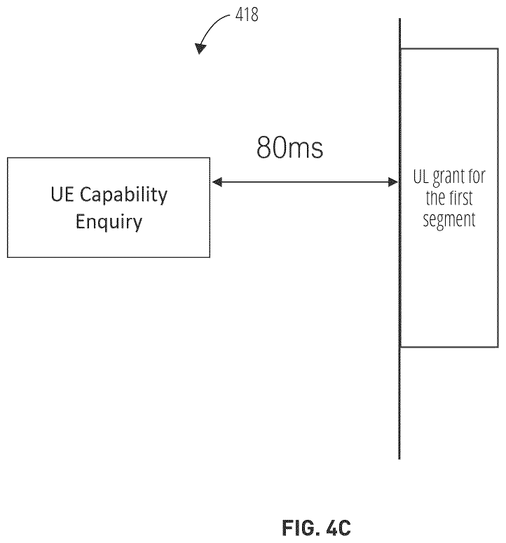

FIG. 4A illustrates an example signal diagram 402 of a capability enquiry procedure with RRC segmentation for UE capability transmission in accordance with some embodiments. The network node 406 may send a UE capability enquiry 408 further, RRC segmentation may be enabled by the network. The network node 406 indicates whether the UE 404 may apply RRC segmentation. In response the UE 404 may send an uplink dedicated message segment 410 when the UE capability size is greater than a certain threshold.

RRC level segmentation may be performed on the UE capability as shown in FIG. 4B. FIG. 4B illustrates RRC capability segmentation in accordance with some embodiments. The RRC message may be ASN.1 encoded 412 first, and the segmentation may be processed on the OCTET STRING. Each segment 414 may be encapsulated into a separate RRC message 416 (ULDedicatedMessageSegment). In some embodiments there may be no interleaving of different RRC messages (e.g., only UE Capability Information can be segmented).

FIG. 4C illustrates an example processing time 418 for RRC segments for UE capability transmission in accordance with some embodiments. As shown, the processing time 418 may be the time between the UE capability enquiry and the uplink grand for the first segment. In the illustrated embodiment, the processing time is 80 ms.

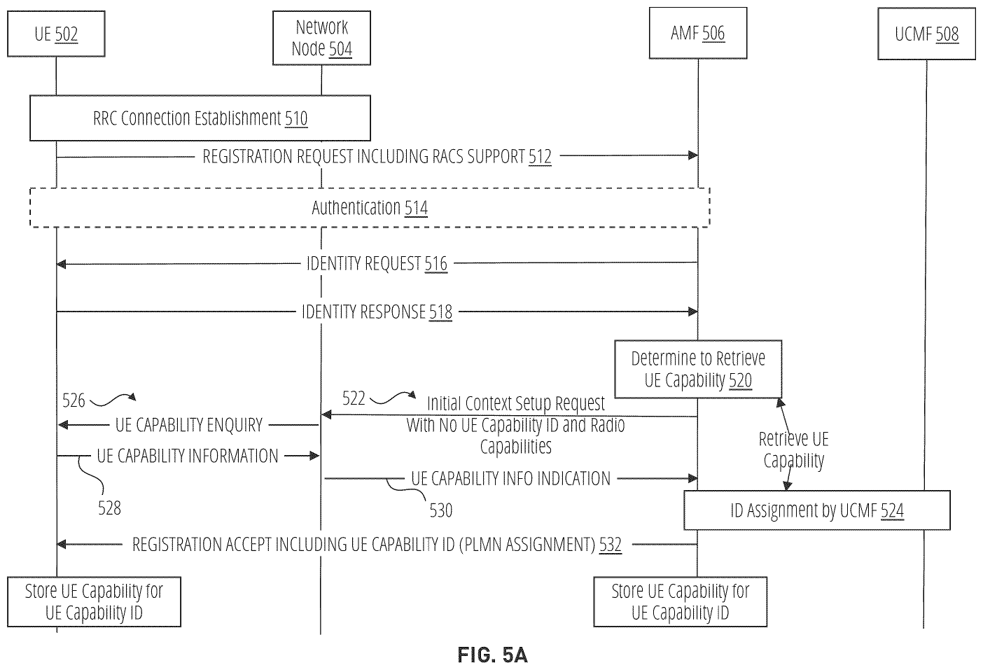

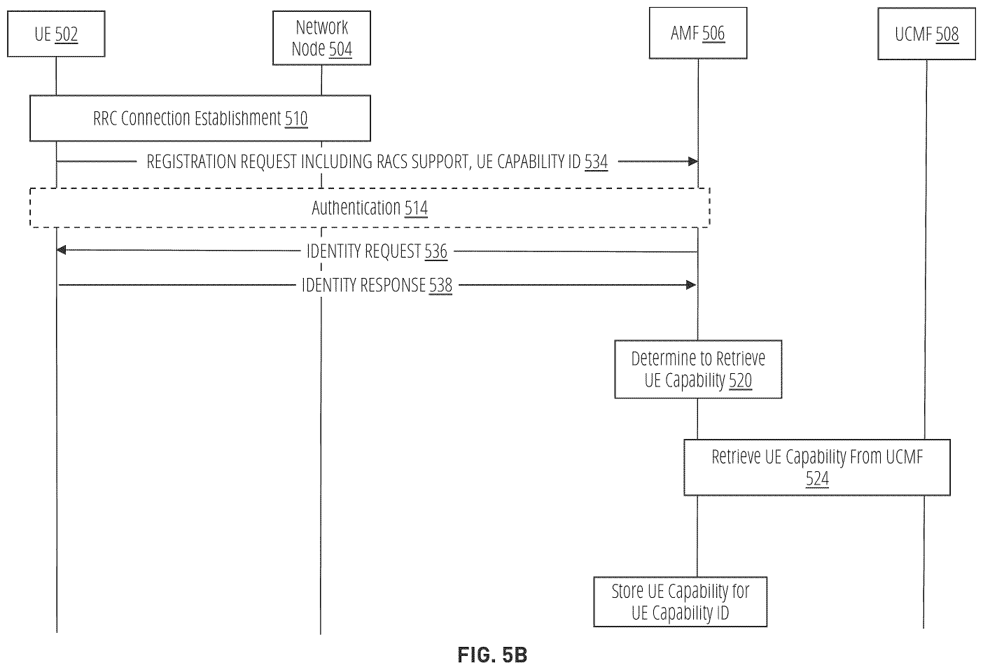

FIG. 5A illustrates an example signal diagram of UE capability transfer using scheme 2 in accordance with some embodiments. In FIG. 5A a PLMN assigned ID assignment is from scratch. As shown, the UE 502 and the network node 504 may perform RRC connection establishment 510. The UE 502 may send a registration request including RACS support 512 to the AMF 506. Authentication 514 may be performed. The AMF 506 may send an Identity Request 516 to the UE 502. The UE 502 may send an Identity Response 518 to the AMF 506. The AMF 506 may determine to retrieve UE capability 520. The AMF 506 may send an initial context setup request 522. The network node 504 may send a UE capability enquiry 526 to the UE 502. The UE 502 may send a UE capability information 528. The network node 504 may send UE capability information indication 530 to the AMF 506. retrieve UE capability from UCMF 524 may be made by the UCMF 508. The AMF 506 may send a registration accept 532 including UE capability ID (PLMN assignment). The UE 502 and the AMF 506 may store UE capability for UE capability ID.

FIG. 5B illustrates a UE capability retrieval from UCMF procedure in accordance with some embodiments. As shown, the UE 502 and the network node 504 may perform RRC connection establishment 510. The UE 502 may send a registration request including RACS support, UE capability ID 534 to the AMF 506. Authentication 514 may be performed. The AMF 506 may send an Identity request 536 to the UE 502. The UE 502 may send an Identity response 538 to the AMF 506. The AMF 506 may retrieve UE capability from UCMF 524 based on the capability ID from the UE 502. The AMF 506 may store UE capability for UE capability ID.

In some wireless communication mechanisms, the UE Capability ID is carried via NAS signaling. The UE Capability ID may include a PLMN assigned ID and a manufacture assigned ID. It may be that the UE Capability ID is associated with a set of AS UE capability, stored at UCMF (e.g., UE radio capability management function). If both UE Radio Capability ID(s) are applicable, the UE can include the PLMN assigned ID in the Registration Request message. At any given time at most one UE Radio Capability ID is stored in the UE context in CN and RAN.

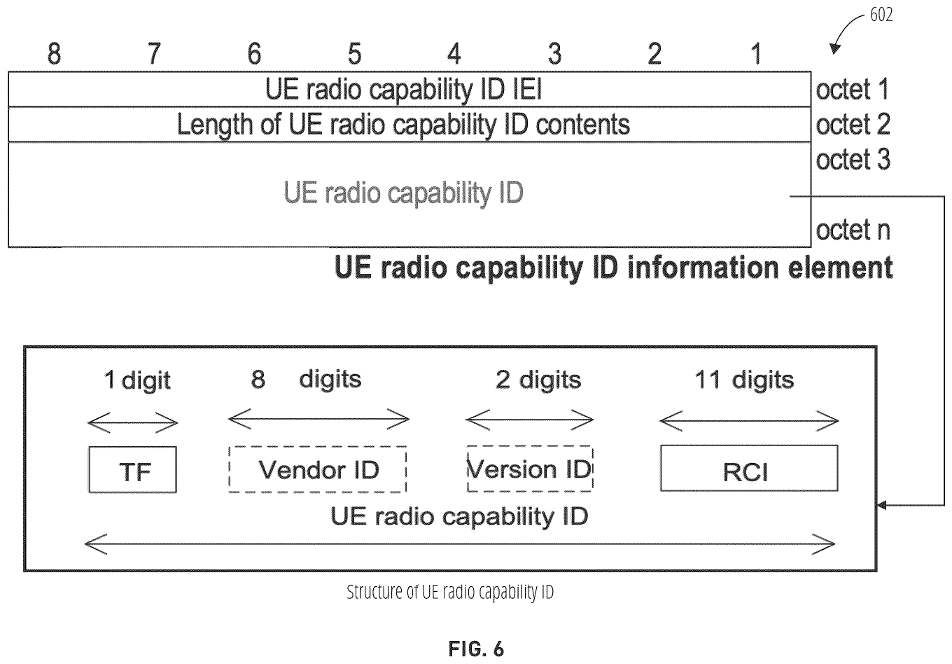

FIG. 6 illustrates an example of a UE Capability ID structure 602 in accordance with some embodiments. The UE Capability ID structure 602 may include a decimal digit, where each digit is converted into four binary bits in NAS information element (IE). The UE radio capability ID is an identifier that may be used to represent a set of UE radio capabilities, defined in 3GPP TS 23.501 and in 3GPP TS 23.401. The UE radio capability ID may be composed of the following elements.

A Type Field (TF) may identify the type of UE radio capability ID. The following values may be defined: 0: manufacturer-assigned UE radio capability ID; 1: network-assigned UE radio capability ID; and 2 to F: spare values for future use.

The Vendor ID may be an identifier of UE manufacturer. This may be defined by a value of Private Enterprise Number issued by Internet Assigned Numbers Authority (IANA) in its capacity as the private enterprise number administrator. Its length may be 8 hexadecimal digits. This field is present only if the Type Field is set to 0. Note that the private enterprise number issued by IANA may be a decimal number in the range between 0 and 4294967295 that needs to be converted to a fixed length 8 digit hexadecimal number when used within the UE Radio Capability ID (e.g., 32473 is converted to 00007ED9).

The Version ID may be the current Version ID configured in the UCMF. This field may be present only if the Type Field is set to 1. Its length may be 2 hexadecimal digits. The Radio Configuration Identifier (RCI): may identify the UE radio configuration. Its length may be 11 hexadecimal digits.

In some cases, the core network supports the system optimizations for the 5GS (provided in 3GPP TS 23.501) and for the EPS (provided in 3GPP TS 23.401), that apply to both NR and E-UTRA, but not NB-IOT, comprising of using UE Radio Capability IDs as an alternative to signaling the UE Radio Capabilities container in system procedures: between the UE and the core network (over Uu); between the CN and the RAN (impacting N2/S1 interfaces); within the RAN in e.g. the handover procedures (impacting Xn/X2/S1/N2 interfaces); within the CN.

The UE Radio Capability ID format may be provided in, for example, 3GPP TS 23.003. Two options for the assignment of UE Radio Capability ID exist. A first may be manufacturer-assigned. The UE Radio Capability ID may be assigned by the UE manufacturer in which case it includes a UE manufacturer identification (i.e., a Vendor ID). In this case, the UE Radio Capability ID uniquely identifies a set of UE radio capabilities for a UE by this manufacturer in any network.

A second may be network-assigned. If a manufacturer-assigned UE Radio Capability ID is not used by the UE or the serving network, or it is not recognized by the serving network's UE Capability Management Function (UCMF), the UCMF may allocate UE Radio Capability IDs for the UE corresponding to each different set of UE radio capabilities which the network may receive from the UE at different times. In this case, the UE Radio Capability IDs which the UE receives are applicable to the serving network and uniquely identify the corresponding sets of UE radio capabilities in this network. The network-assigned UE Radio Capability ID includes a Version ID in its format. The value of the Version ID is the one configured in the UCMF, at the time when the UE Radio Capability ID value is assigned. The Version ID value makes it possible to detect whether a UE Radio Capability ID is current or outdated.

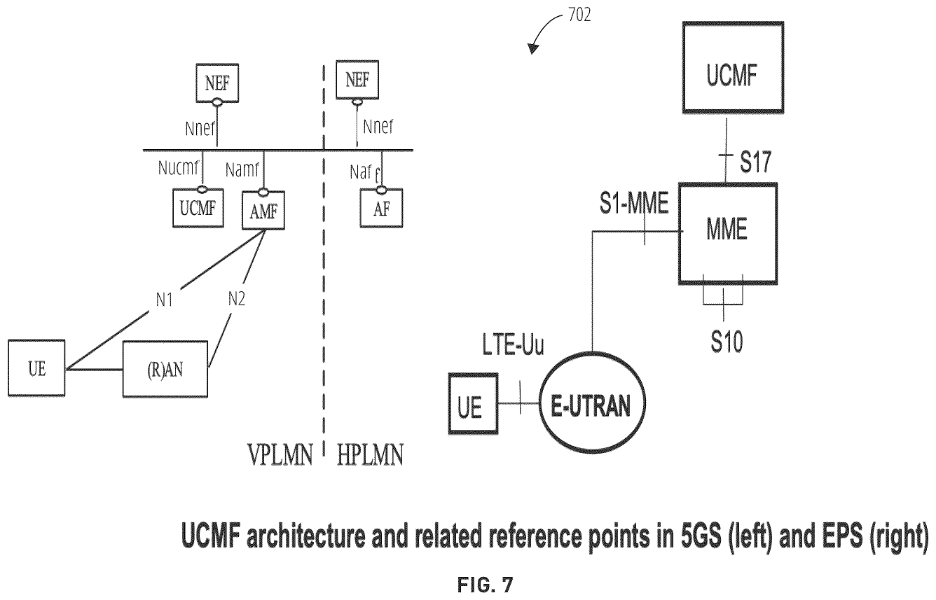

FIG. 7 illustrates an example of UCMF architecture 702 and related reference points in 5GS and EPS in accordance with some embodiments. In certain wireless communication mechanisms, a core network function called the UE Capability Management Function (UCMF) is introduced to assign, store and map the UE Radio Capability IDs and corresponding UE radio capabilities. The UCMF may be used for: storage of dictionary entries corresponding to either Network-assigned or Manufacturer-assigned UE Radio Capability IDs; assigning Network-assigned UE Radio Capability ID values; provisioning of Manufacturer-assigned UE Radio Capability ID entries in the UCMF performed from an AF that interacts with the UCMF either directly or via the NEF/SCEF (or via Network Management).

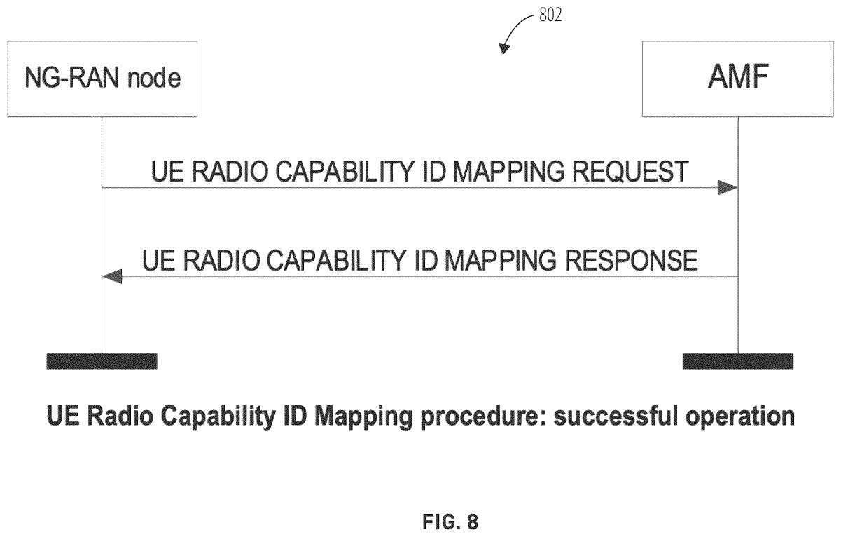

FIG. 8 illustrates an example of a UE radio Capability ID mapping procedure 802 in accordance with some embodiments. In some cases, the Capability ID is not delivered in the message between UE and network node. The Capability ID can be usage in NG-RAN/network node and between the network node and the AMF. The AMF can deliver the UE capability to network node via Capability ID instead of legacy UE capability. When the network node needs to retrieve the mapping of a UE Radio Capability ID to the corresponding UE Radio Capability information, it may query the AMF using UE Radio Capability ID Mapping procedure. The network node may perform local caching of the UE Radio Capability information for the UE Radio Capability IDs for the UEs it is serving, and potentially for other UE Radio Capability IDs according to suitable local policies.

In some wireless communication systems, in 5G capability design, the UE capability design and its corresponding procedures use a common structure applicable to all types of UEs. The control signaling is also common for 3GPP features which can be reported at different granularities such as per UE, per band, per band per band combination, and per band combination. The UE capability change/update is only done via NAS signaling procedure (i.e., registration procedure).

The restriction of 5G capability design may include that the signaling structure and procedures do not allow to signal which UE capabilities are associated with a specific device type (RedCap, NB-IoT, etc.) or a specific 3GPP feature. The signaling size of UE capabilities has increased significantly, as many of the capabilities introduced in later 5G releases have been defined at the smallest granularity in pursuit of uncertain flexibility. The UE capability parameters cannot be used for marketing purposes directly (similar as UE category in LTE). The complexity to notify the network of changes in UE capability (e.g., via NAS signaling) is too significant.

In some cases, potential 6G parameters on UE capability design may be introduced. In the 6G era, with the introduction of more diverse communication and business forms, one UE may act as a different type of device at different times, and with different UE capabilities. The device may change its UE capability under some conditions (e.g., MUSIM). It may be beneficial for a UE to adjust its capabilities in a more dynamic fashion to cope with challenging conditions or when circumstances change (e.g., UE power situation).

With the existing UE capability structure in 5G, it is not generally feasible to associate (or even confine) a UE capability set with a device type or a specific 3GPP feature (work item). In some embodiments, 6G enhancements and UE capability designs may be introduced to allow for more flexible adjustments of UE capabilities (e.g., the applicable capabilities can dynamically change). In some cases, the UE capability design may extend in a manner that is also suitable for marketing purposes.

Embodiments herein may enhance wireless communication systems by implementing one or more of the following directions. In some embodiments, a first direction (Direction 1) may extend the UE capability design in a manner that is also suitable for marketing purposes. Introduce the UE category concept and assume at least one band combination (BC) (flexible capability) can meet the physical (PHY) requirement.

In some embodiments, a second direction (Direction 2) may reflect the relationship between capabilities and features and/or conditions. Some embodiments may group the capability set in feature, device, or condition level. The capability request and report may be at the feature, device, or condition level.

In some embodiments, a third direction (Direction 3) may include dynamic switching of applicable UE capabilities. For example, a first option may include that the network sides stores multiple capability sets, and the network can select one from the capability sets to apply based on some conditions. A second option may be that the UE reports the changed UE capabilities (full set or delta set) based on current configuration to the network.

In some embodiments, a fourth direction (Direction 4) may reduce the signaling overhead. For example, a first option may apply the UE capability ID mechanisms, to reduce the number of times UE capabilities are transmitted via the Uu interface. A second option may include UE capability reporting in two levels: coarse granularity of capability, and finer granularity which may be based on a current configuration.

In some embodiments, UE category indicators may be used. For example, in embodiments that include enhancements for Direction 1, the UE capability design may be extended in a manner that is also suitable for marketing purposes. Some embodiments may introduce the UE category concept and assume at least one BC (flexible capability) can meet the PHY requirement.

Some embodiments may introduce one or more UE category indicators for each specific UE device type. The UE category indicators may indicate the type of the UE devices and which class the UE belongs to. Each category indicator may be used to represent the following information. The category indicator may be used to represent the UE device type (e.g., RedCap UE, enhanced Mobile Broadband (eMBB) UE, Satellite UE, XR UE. The category indicator may be used to represent the UE level in the specific device type (e.g., High-end, mid-end, low-end).

In some embodiments, one category indicator may correspond to one reference capability (set). The reference capability set can be predefined in specification, defined by operators/vendors, or indicated by the UE as part of an initial signaling exchange (e.g., including optional parameters). If the UE supports the category indicator, UE should support the reference capability (set).

The relationship between the category indicator and the reported UE capabilities may indicate what the UE supports. In some cases, if the UE supports the category indicator #X, the reference capability set #X can be the minimum capabilities. For instance, the capabilities reported by UE may be the super set of the reference capability set #X. In some other cases, if the UE supports the category indicator #X, the reference capability set #X can be the maximum capability set. For instance, at least one capability reported by UE is the same as the reference capability set #X.

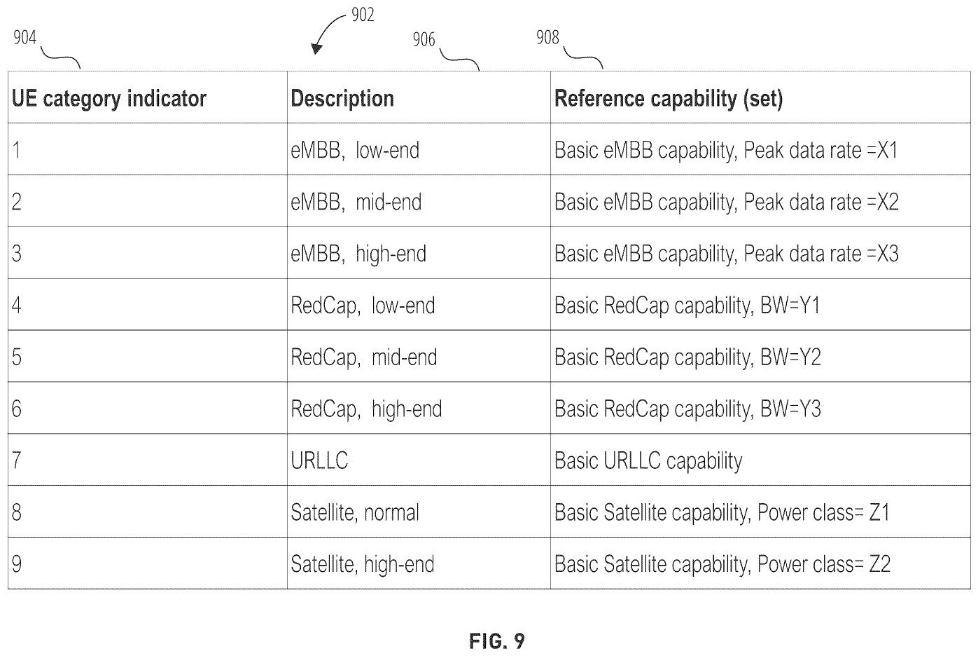

The UE category indicator may correspond to a reference capability (set). Some embodiments may use a unified numbering across all levels and level combinations (e.g., all category indicators are defined in table 902 of FIG. 9). In some embodiments, the indicators may be numbered separately for different level types. For example, different tables may be defined for different level types. For instance, a table for device type may be defined, a table for feature may be defined, a table for condition may be defined.

In some embodiments, the indicator may be split into multiple tables. For example, one table may be defined for a device type. The UE may be allowed to indicate multiple UE categories at the same time.

The UE may report the UE category indicator to the network. Regarding UE category indicator reporting, if the UE can report multiple capability sets to the network, the UE can indicate separate UE category indicators, one per capability set for that level (device type/condition/feature).

FIG. 9 illustrates an example table 902 that may be used by the UE and the network to define UE category indicators 904 in accordance with some embodiments. As shown, a first column may include UE category indicators 904. The UE category indicators 904 may be used by the UE to indicate to the network the UE's capability and may be included in a UE capability report. Each UE category indicator 904 may correspond to a description 906 and a reference capability (set) 908. For example, in the illustrated embodiment, UE category indicator #1 corresponds to a low-end level eMBB device with basic eMBB capability and a peak data rate=X1. The reference capability (set) 908 may indicate the capability of the device.

Some embodiments may reflect the relationship between capabilities and features/devices/conditions (direction 2). In some embodiments, for Direction 2, the capability set may be grouped at the feature, device, and/or condition level. The capability request and report may be at the feature, device, and/or condition level. The conditions may define certain states of the device. For example, a condition may include, for example, a power condition (e.g., low power, normal power, etc.), UE location in the cell (at cell edge or not), or constrained device (e.g., due to high CPU load). Note that the network may be able to configure the UE with a predefined set of conditions in some embodiments. The conditions may also vary for different features/device types. The device type may include, for example, a RedCap device and/or a XR device. The feature may be, for example, RedCap, eMBB, or satellite.

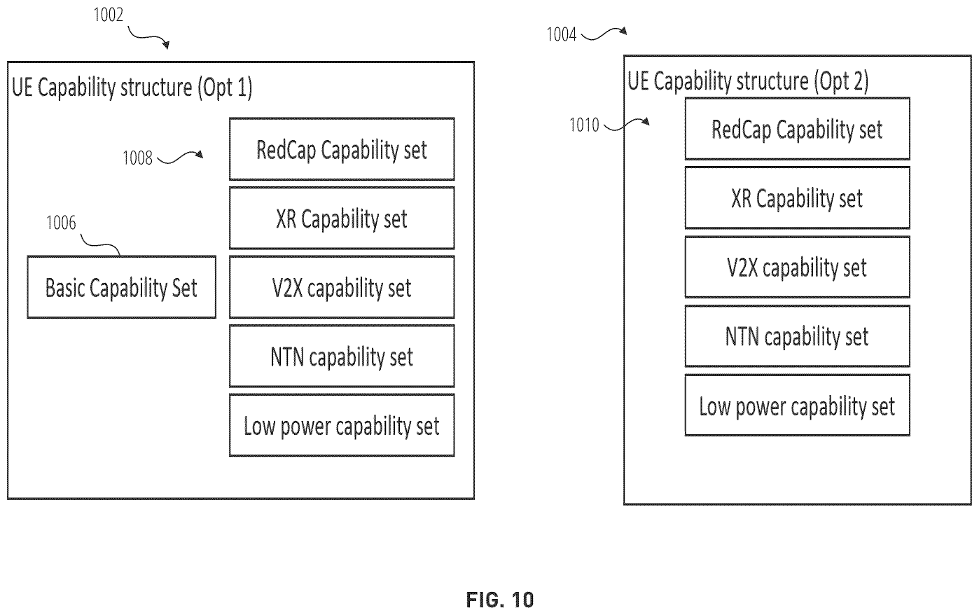

One UE can report multiple capability sets. In some embodiments, the UE my report a basic set of capabilities that is common to each of the different capability sets, and report specific features for each of the individual sets (e.g., Basic set+Feature #1 set+Feature #2 set+ . . . +Feature #N set). In some embodiments, the UE may report each different capability set in full (e.g., Set #1+Set #2+ . . . . Set #N). For example, FIG. 10 illustrates two example UE capability structures that a UE may use to report the capability sets in accordance with some embodiments.

The first UE capability structure 1002 includes a basic capability set 1006 that reports basic capabilities across the different device types. The first UE capability structure 1002 also includes multiple feature sets 1008 that reports specific capability sets for different features. The second UE capability structure 1004 includes multiple full capability sets 1010 for each feature.

The network can request one capability set in one specific level. Note that the specific level refers to a particular condition, device type, or feature as describe previously. In a network capability request, the network can explicitly indicate to request UE capability for a specific level. The UE may report the capability set associated with that level.

In some embodiments, the network can request capability sets for multiple levels or features. The UE may report back a capability set for each level requested plus a capability set for the combination of the multiple levels. For example, if the network requests a feature #A+feature #B set, the UE can report three capability sets: Capability set #1 for feature #A; Capability set #2 for feature #B; and Capability set #3 for feature #A+feature #B.

The network can store the multiple capability sets at the CN side or/and at the RAN side.

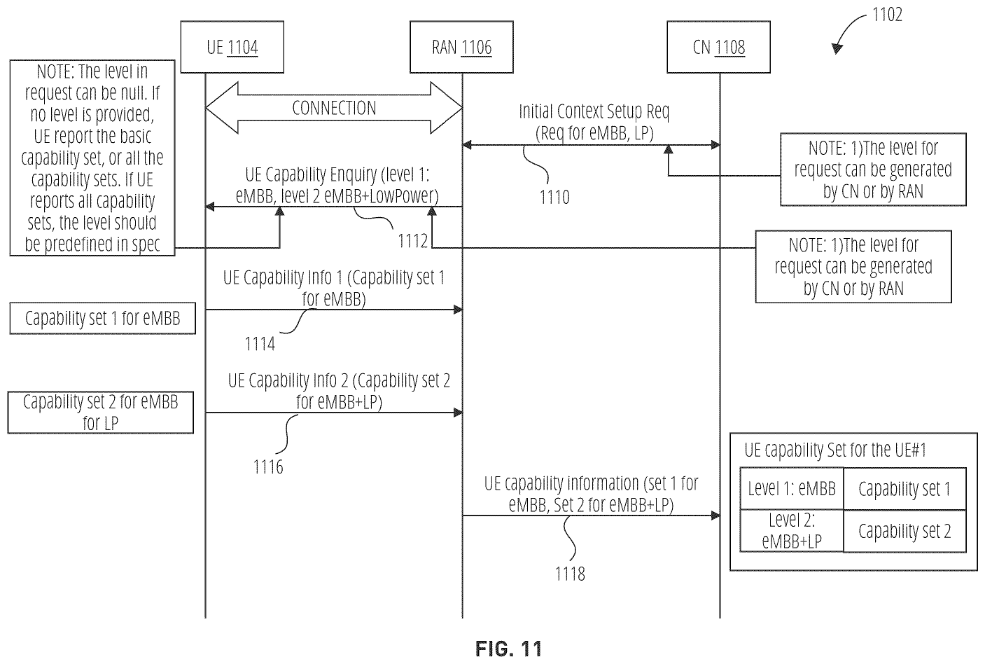

FIG. 11 illustrates an example signal flow diagram 1102 of a UE capability request and report procedure with multiple capability sets, according to embodiments herein. As shown, the UE 1104 and the RAN 1106 (e.g., network node) may establish a connection. The core network 1108 may send the RAN 1106 an initial context setup request 1110. The level for the initial context setup request 1110 can be generated by the core network 1108 or the RAN 1106. In the illustrated embodiment, the initial context setup request 1110 includes a request for UE capability for eMBB and low power.

The RAN 1106 may send a UE capability enquiry 1112 to the UE 1104. The UE capability enquiry 1112 may request one or more capability sets for one or more specific levels (e.g., condition, device type, feature). For example, in the illustrated embodiment, the UE capability enquiry 1112 includes a request for capabilities regarding two levels. In the illustrated embodiment, the level 1 request is for to eMBB capabilities and the level e request is for to eMBB capabilities plus low power. Note that the level in the UE capability enquiry 1112 can be null. If no level is provided, the UE 1104 can report the basic capability set, or all the capability sets. If the UE 1104 reports all capability sets, the level may be predefined in specification.

The UE 1104 can report multiple capability sets based on the UE capability enquiry 1112. In the illustrated embodiment, the UE 1104 generates and sends capability sets for eMBB and eMBB for low power. As shown, the UE 1104 may send the capability set for eMBB in a first UE capability information 1114 and may send the capability set for eMBB for low power in a second UE capability information 1116. In some embodiments these capability sets may be sent in a single response message.

The RAN 1106 may send the UE capability information 1118 with the capability set for eMBB and the capability set for eMBB for low power to the core network 1108. The RAN 1106 and/or the core network 1108 may store the multiple capability sets. The multiple capability sets may be used for upcoming connection configurations.

Some embodiments may implement dynamic capability changes (direction 3). For instance, in some embodiment a network node may perform a dynamic change between the capability sets stored in the network side. It may be assumed that the network stores multiple UE capability sets and the associated levels in network side. The network can dynamically select the UE capability from the multiple capability sets based on current situation. In some examples, the current situation may be determined based on UE capability indication. In some other examples, the current situation may be determined based on network knowledge according to current deployment and/or the selected network info (e.g., the network slice, the network type).

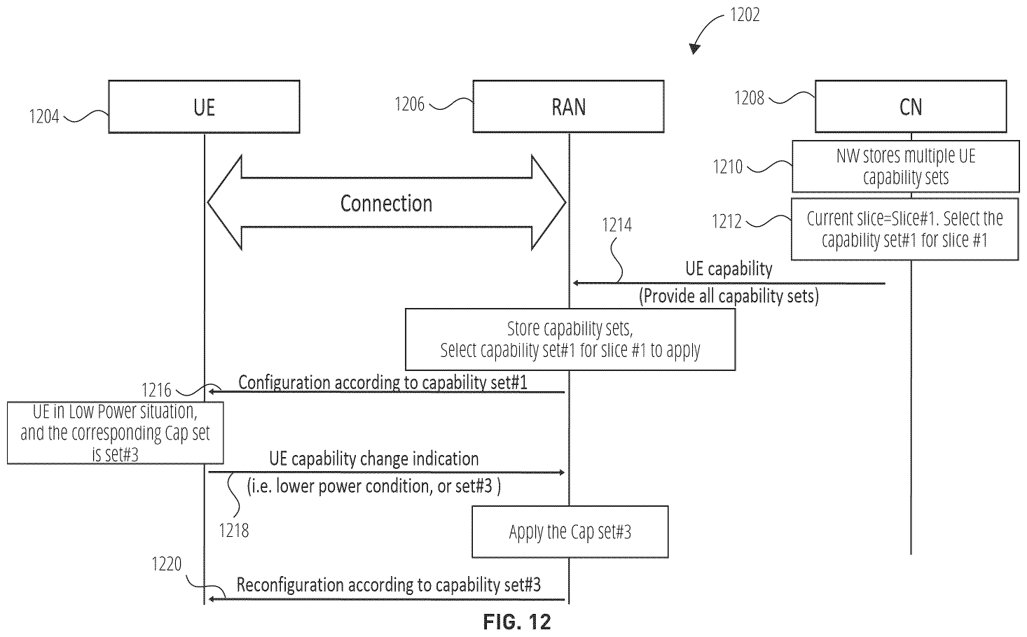

FIG. 12 illustrates an example signal flow diagram 1202 of a dynamic change between the capability sets stored in network side in accordance with some embodiments. As shown, the network may store 1210 multiple capability sets for the UE 1204. Note that the multiple sets could be acquired from the UE via a previous connection or based on pre-defined sets in the specification. In the illustrated embodiment, the network stores two category sets for the UE 1204. For example, Set #1 may be a capability set 1212 for network slice #1, Set #2 may be a capability set for network slice #2, Set #3 is for LowPower. During the connection establishment procedure, the core network 1208 may provide all UE capability sets to RAN 1206 via the downlink message 1214. The RAN 1206 may be aware that current UE access is in slice #1, and apply the capability set #1 to provide the configuration 1216. During the connection, the UE 1204 may detect it enters low power situation. The UE 1204 may report the low power indication to RAN 1206 via AS signaling (e.g., low power condition included in UE capability change indication 1218); or UE 1204 can report capability set #3 (e.g., set #3 included in UE capability change indication 1218). The network may apply the capability set #3 for the configuration and send a reconfiguration message 1220 according to capability set #3.

In some embodiments, for dynamic capability change (direction 3), the UE may report the changed UE capabilities (full set or delta set) based on current configuration to the network. For example, the UE may determine a change for the UE capabilities and may report the new capability to the network for implementation. It may be assumed that the network stores the basic/default capability set in core network side. The network may provide the configuration to UE based on the default capability or the capability stored in network side. The network can provide the potential configuration information to UE (e.g., band for carrier aggregation or for PCell), and UE can report the capability (e.g., MIMO) based on it to network via RRC response message. Furthermore, the UE can also provide the applicable capability (delta part) based on current activated configuration via network L1/L2 control (e.g., bandwidth part (BWP) switching, SCell activation).

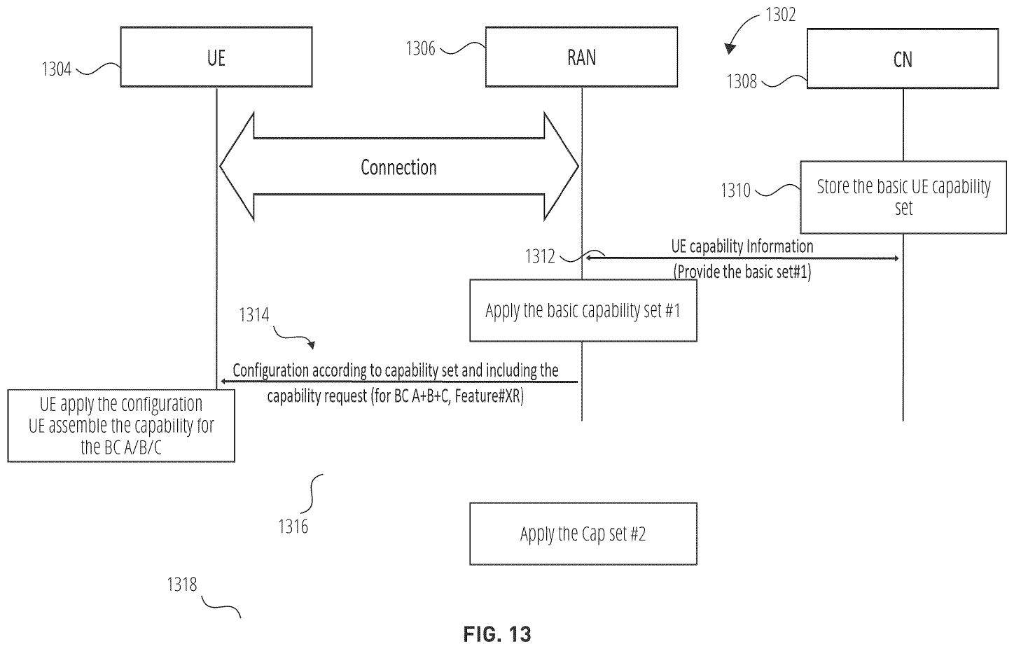

FIG. 13 illustrates an example signal flow diagram 1302 where the UE 1304 reports the capability based on the current connection for a dynamic capability change in accordance with some embodiments. The network may store 1310 the basic UE capability set. The core network 1308 may provide the UE capability information 1312 for the basic set to the RAN 1306. The RAN 1306 may apply the basic capability set and provide the initial RRC configuration 1314 to the UE 1304 based on the basic UE capability set. In the initial RRC configuration 1314, the RAN 1306 may explicitly indicate to the UE 1304 to provide the capability request related to one or more levels (e.g., band A, B, C and XR specific capability).

The UE 1304 may report the capability based on the request condition in the RRCResponse message 1316. The RAN 1306 may apply the capability set reported by the UE 1304 and send a reconfiguration message 1318 according to the capability set sent by the UE 1304.

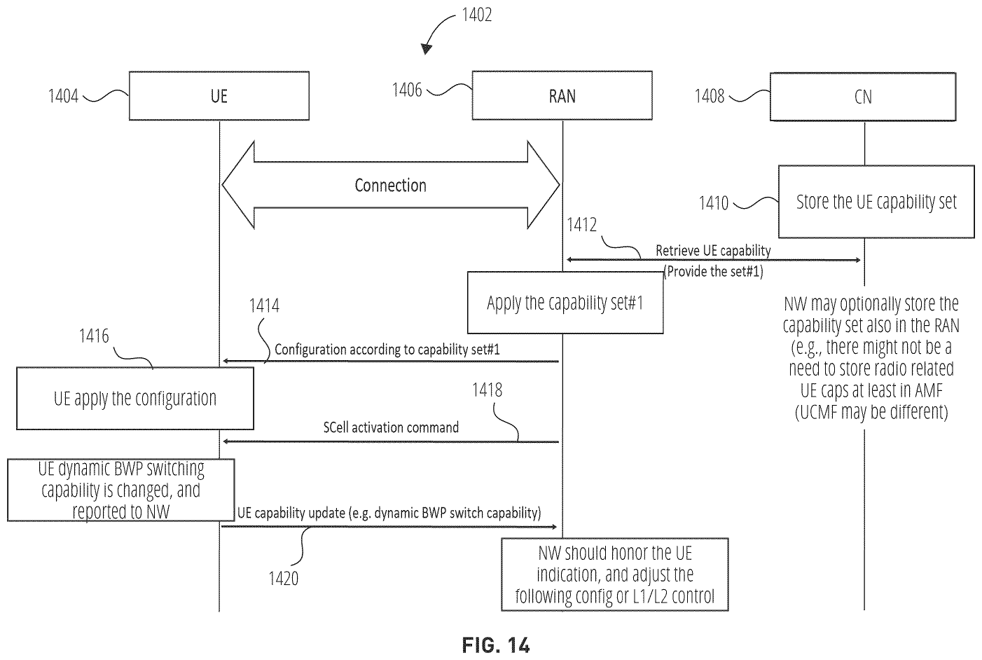

FIG. 14 illustrates a signal flow diagram 1402 where the UE 1404 reports the capability based on the activated configuration via network L1/L2 control for a dynamic capability change, according to embodiments herein. The network may store 1410 the basic UE capability set. The network may optionally store the capability set also in the RAN (e.g., there might not be a need to store radio related UE caps at least in AMF (UCMF may be different).

The core network 1408 may provide the UE capability information 1412 for the basic set to the RAN 1406. The RAN 1406 may apply the basic capability set and provide the initial RRC configuration 1414 to the UE 1404 based on the basic UE capability set. The UE 1404 may apply 1416. The RAN 1406 may send an SCell activation command 1418 to the UE 1404

The UE 1404 may have different capability of dynamic BWP switching on different carrier aggregation (CA) configurations (e.g., number of SCell, frequency range (FR), bandwidth (BW)). The UE may not report such capability which are stored in network side. When the CA is configured, upon each SCell activation command reception, the UE 1404 may, based on the current activated SCell situation, provide network the dynamic BWP switching capability if it is changed. For instance, as shown, the UE 1404 may change the UE dynamic BWP switching capability based on the SCell activation. The UE 1404 may provide a UE capability update 1420 (e.g., dynamic BWP switch capability for SCell) to the RAN 1406. The network may honor the UE indication and adjust the following configuration or L1/L2 control.

Some embodiments may implement mechanisms to reduce the signaling overhead (direction 4). In some embodiments, to reduce the signaling overhead, the UE may apply capability ID mechanisms to reduce the number of times UE capabilities are transmitted via Uu. A restriction in a wireless communication system may be that at any given time at most one UE Radio Capability ID is stored in the UE context in core network and RAN. However, in some embodiments, one UE can have multiple capability IDs. For example, the UE may have one capability ID per capability set per level (e.g., feature, device, condition) (NOTE: capability set as indicated in direction 2). The level can be condition level or device type level or feature level or combination.

In some embodiments, the UE capability reporting may be performed in two granularities: a coarse granularity and a finer granularity. A restriction in warless communication systems may include that the UE capability includes all the parameters in different granularities and is stored in network side. For the finer granularity capabilities (e.g., per band, per Feature Set per Component Carrier (FSCC)), there may be huge numbers of values reported in different situations. In some embodiments, the capabilities in coarse granularity (e.g., per band combination, per UE) may be reported by UE and stored at the network in a static way. The capabilities in finer granularity (e.g., per FSCC, per band per band combination) may be reported by UE based on the configuration in each connection in dynamic way.

In some embodiments, for the UE capability ID mechanism case discussed herein, multiple UE radio capability IDs may be supported per UE for reporting and storing in network side (core network and RAN). The different UE capability IDs (associated with different capability sets) can be associated with different conditions. In a first example, there may be different capability IDs for the UE in different power conditions, (e.g., capability ID set to 1 for normal power, and capability ID set to 2 for lower power). In a second example, there may be different capability IDs for the UE in different role, (e.g., 1 for RedCap; 2 for RedCap with XR). In a third example, different capability IDs for the UE in different slices (e.g., 1 for Slice #1, 2 for Slice #2).

The UE may report the multiple capability IDs associated with the conditions to the core network via Non-Access Stratum (NAS) signaling. If the core network cannot find the capability ID for the condition, the network can trigger the RAN to fetch the UE capability. The UE capability retrieval procedure in RAN side may be based on the condition which is indicated in the request message.

When the UE enables the initial access and enters connected mode, the network can identify the UE condition (e.g., power, slice, role). In some embodiments, the core network may forward all capability sets to RAN, and the RAN, based on the condition, may provide the configuration. In some embodiments, the core network may identify the condition and decide the applied capability ID, and provide the capability set to the RAN. Note that the network can identify the condition by itself or based on UE reported information.

The UE may indicate the current condition or capability ID via the capability reporting message to RAN. The network may update the activated UE capability set according to the indicated condition/ID, and to update the configuration accordingly.

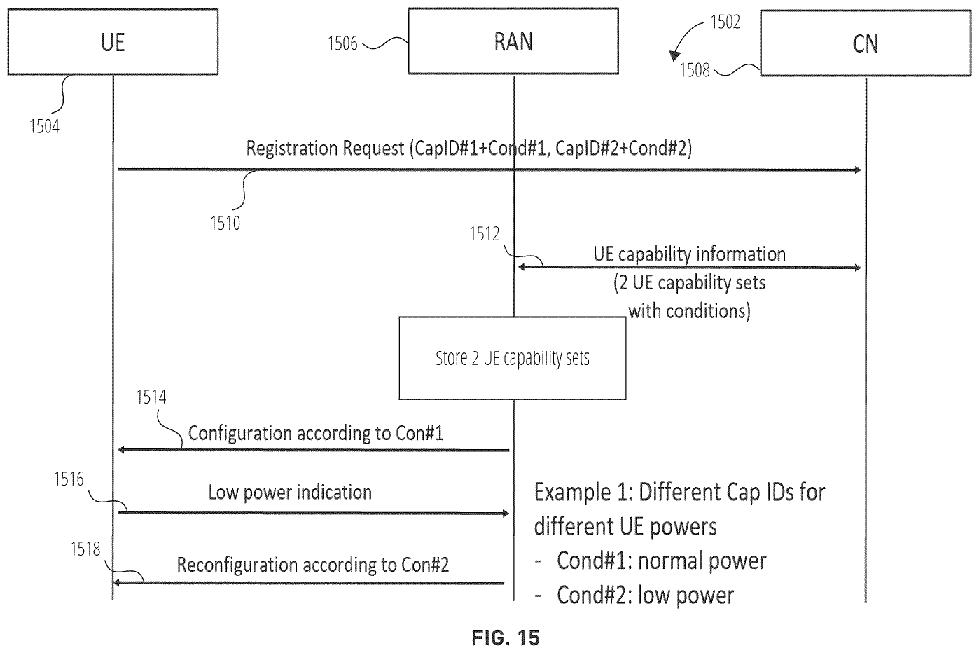

FIG. 15 illustrates an example signal flow diagram 1502 using a UE capability ID mechanism, according to embodiments herein. In some embodiments, for the UE capability ID mechanism discussed herein, the core network 1508 may provide multiple capability sets to RAN 1506, and RAN 1506 may, based on the condition, select the applied capability set. It may be assumed that the network already stores UE capability ID and the associated capability sets/condition.

The UE 1504 may report multiple capability IDs via NAS registration request 1510. For example, the UE 1504 may report two capability IDs, a first for normal power and a second for lower power condition via NAS registration request. The condition may be optionally provided. The core network 1508 may acquire the associated capability set and condition from the two IDs, and provide them to RAN 1506 (e.g., UE capability information 1512). The RAN 1506 may store the two capability sets, and apply the capability for normal power condition (e.g., set #1) (e.g., send the configuration 1514 according to condition #1). The UE may send a low power indication 1516 to inform the RAN 1506 that the UE 1504 is in low power condition. When the UE 1504 informs RAN 1506 of the Low power case, RAN 1506 may switch the applied capability to set #2 and send a reconfiguration message 1518 according to condition #2.

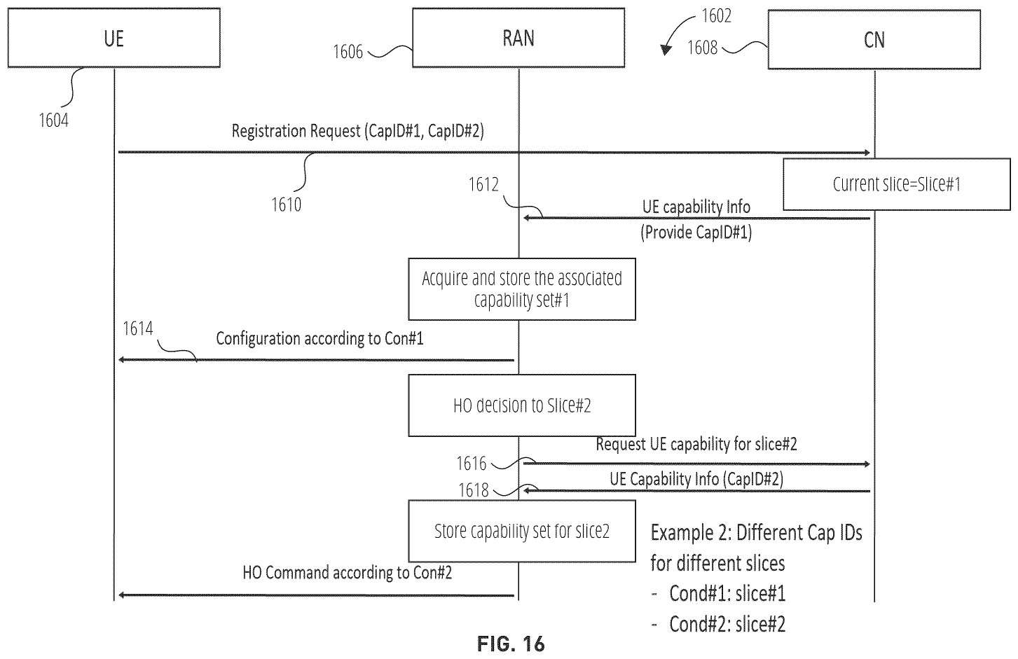

FIG. 16 illustrates an example signal flow diagram 1602 using a UE capability ID mechanism based on slices, according to embodiments herein. In some embodiments, for the UE capability ID mechanism discussed herein, the core network 1608 may provide multiple capability sets to RAN 1606, and RAN 1606 may, based on the condition, select the applied capability set. It may be assumed that the network already stores UE capability ID and the associated capability slices (e.g., slice #1 and slice #2).

The UE 1604 may report multiple capability IDs via NAS registration request 1610. For example, the UE 1604 may report two capability IDs. The core network 1608 may acquire the associated capability sets for slice #1 and slice #2. The core network 1608 may, based on current UE access (slice #1), provide the capabilityID #1 to RAN 1606 (e.g., UE capability information 1612 that includes capabilityID #1). The RAN 1606 may provide a configuration to the UE 1604 based on the capability ID (e.g., send the configuration 1614 according to condition #1). The RAN 1606 may find the capability set associated with CapabilityID #1, and provide the configuration.

When the UE 1604 is handed over to another cell in slice #2, the RAN 1606 may send a request 1616 to the core network 1608 for capability in Slice #2. The core network 1608 may provide Capability set #2 1618 to the RAN 1606. The RAN 1606 may store the capability set for slice #2 and send a handover command to the UE 1604 according to condition #2.

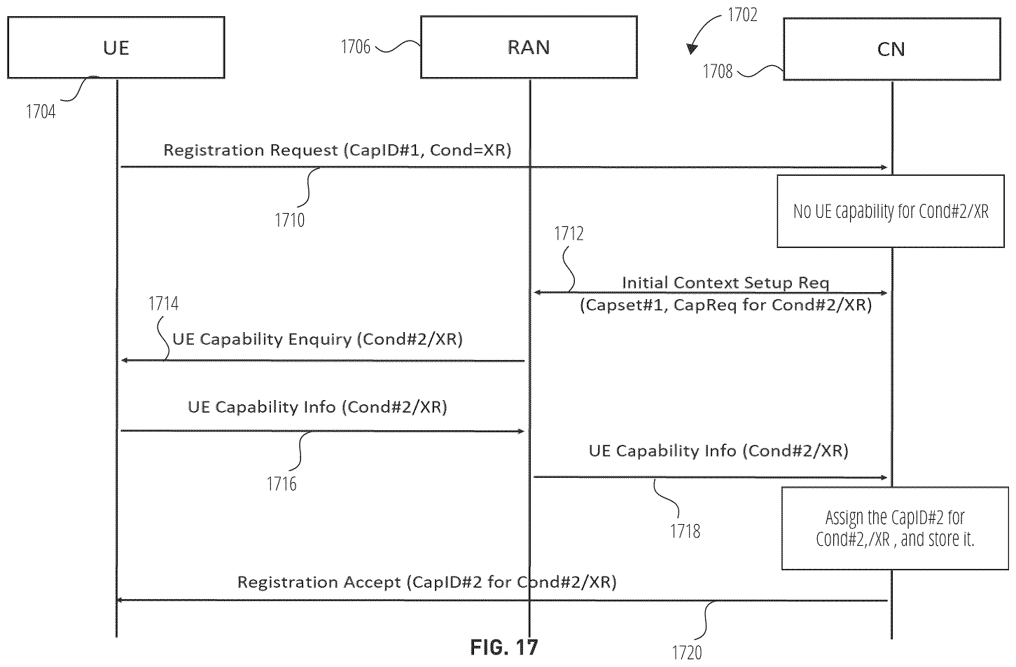

FIG. 17 illustrates an example signal flow diagram 1702 for UE capability retrieval, according to embodiments herein. In some embodiments using the UE capability ID mechanism discussed herein, the network can trigger the UE capability retrieval procedure to request UE capability set to a specific condition. In some embodiments, the UE 1704 can inform network it has capability for Condition #2, and core network 1708 can trigger the UE capability retrieval for Condition #2, and assign a capability ID to Condition #2.

In the illustrated embodiment, it may be assumed that the network already has the UE eMBB capability set and associated it with CapID #1. During registration procedure, the UE 1704 reports its capabilityID #1, and new condition with XR via a registration request 1710. A new condition (e.g., XR) in the registration request 1710 indicates that the UE 1704 would like to provide the XR capability to network for storage. The core network 1708 may determine that it does not currently have UE capability for the XR condition scored. The core network 1708 may request that the RAN 1706 initiates a UE capability retrieval procedure for XR condition. For example, the core network 1708 may send the RAN 1706 an initial context setup request 1712 that includes a request for the capability information for the XR condition.

The RAN 1706 may initiate the UE capability retrieval for XR. The RAN 1706 may request that the UE 1704 to provide XR capability via a UE capability enquiry 1714. The UE 1704 may report the XR capability to the network via a UE capability information message 1716. The RAN 1706 may forward the XR capability to core network 1708 (e.g., message 1718). The core network 1708 may store the XR capability and assign CapID #2 for it, and inform the UE 1704 of the CapID via a registration accept message 1720 The UE 1704 may store the association between the XR capability and CapID #2.

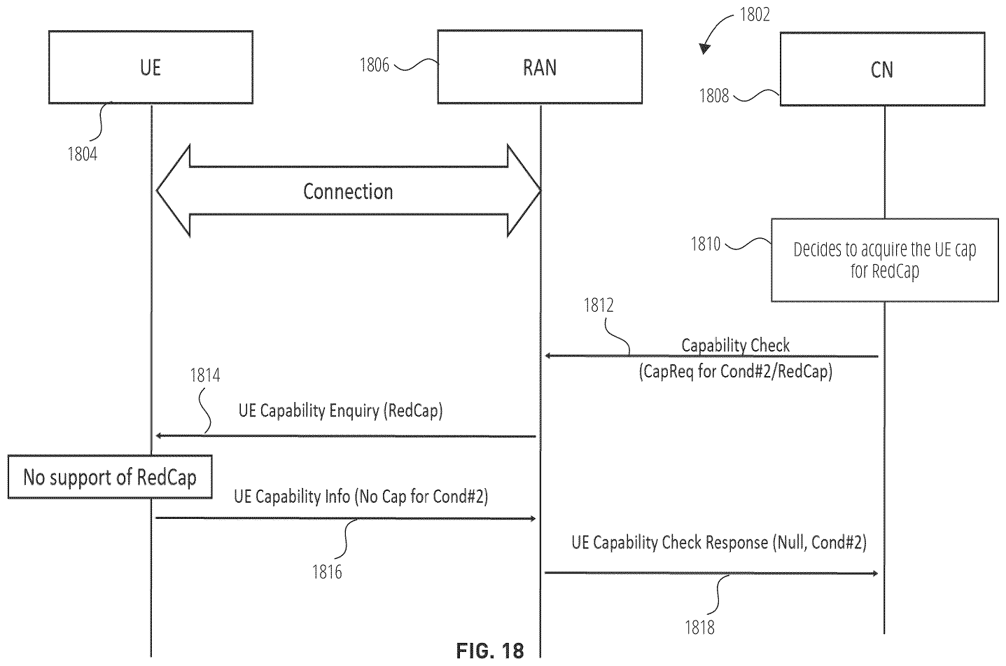

FIG. 18 illustrates a signal flow diagram 1802 for UE capability retrieval, according to embodiments herein. In some embodiments using the UE capability ID mechanism discussed herein, the network can trigger the UE capability retrieval procedure to request UE capability set to a specific condition. In some embodiments, the network can actively request that the UE 1804 provide the capability set to the core network 1808 for a new Condition. If UE 1804 has no such capability set for the requested Condition, the UE 1804 can report Null set to network or indicate UE 1804 it has no specific capability for it.

The UE 1804 and RAN 1806 may establish a connection. The core network 1808 may decide 1810 to acquire the UE capability for RedCap. The core network 1808 may trigger UE report RedCap capability, and inform the RAN 1806 of the request condition for RedCap. For example, the core network 1808 may send a capability check message 1812 to the RAN 1806 that includes the requested condition (e.g., RedCap).

The RAN 1806 may trigger the UE capability retrieval procedure for RedCap. For example, the RAN 1806 may send a UE capability enquiry 1814 that indicates which condition the network is requesting a capability set for. In the illustrated embodiment, the condition is for RedCap. In the illustrated embodiment, the UE 1804 has disabled the RedCap mode (e.g., no support of RedCap), and indicates this lack of support for RedCap capability to the network via a UE capability information message 1816. The RAN 1806 may forward the null redcap capability or indicate that the UE does not support RedCap by sending a UE capability check response 1818 to the core network 1808.

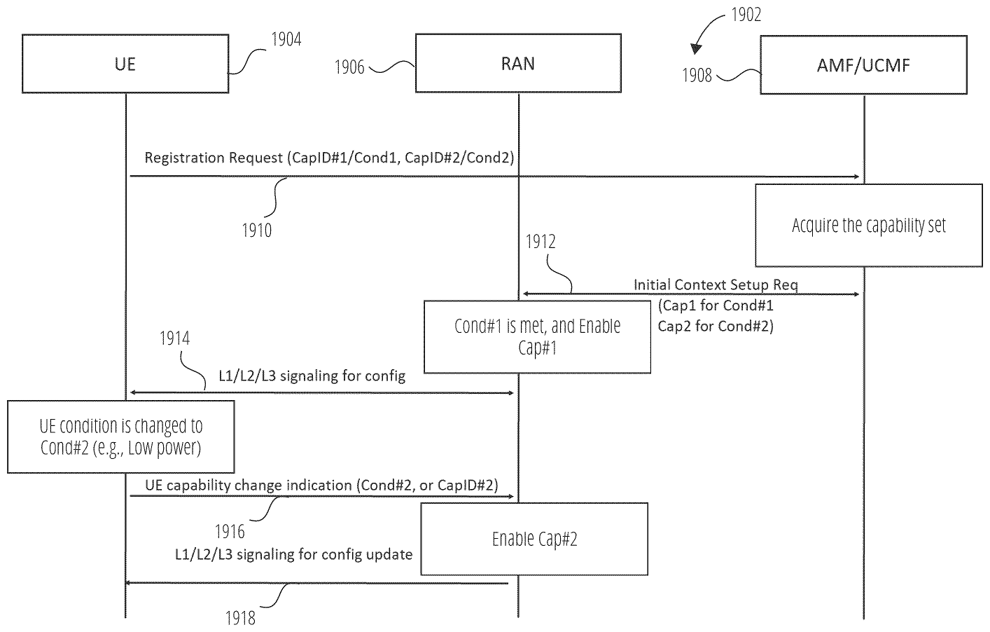

FIG. 19 illustrates a signal flow diagram 1902 where the UE 1904 informs network about the capability change using a UE capability ID mechanism in accordance with some embodiments. The UE 1904 may report multiple capability IDs via NAS registration request 1910. For example, the UE 1904 may report two capability IDs, a first for normal power and a second for lower power condition via NAS registration request. The UE 1904 may also provide the conditions in the NAS registration request 1910.

The core network 1908 may acquire the associated capability set and condition from the two IDs. The core network 1908 may store multiple capability IDs for the UE 1904, and understand the different capability ID for different conditions.

The core network 1908 may forward both capability IDs together with conditions to RAN 1906 via an initial context setup request 1912. The RAN 1906 may be aware of the capability set indicated by capability ID by itself (e.g. RAN 1906 can access the library to acquire it). The RAN 1906 decides to enable capability set #1 due to the current condition #1 is met (e.g. normal power) and may send signaling 1914 for the configuration based on capability set #1.

At times, the condition may change at the UE 1904 (e.g., enter condition #2). When the condition changes to condition #2 (e.g., UE 1904 enters lower power mode), the UE 1904 may inform RAN 1906 to switch to CapID #2. The network follows the UE 1904 request and applies the set #2. For example, in the illustrated embodiment, the UE 1904 sends a UE capability change indication 1916 that includes either the condition or the capability ID corresponding to the updated condition, and the RAN 1906 enables the corresponding capability set and sends a configuration update 1918 based on the corresponding capability set.

In some embodiments, a two-level UE capability report may be implemented (e.g., coarse granularity and finer granularity). In some embodiments, the first level UE capability may include a default UE capability set. The default UE capability set may be predefined (e.g., predefined in the 3GPP specification).

In some embodiments, the first level UE capability may include static capability with coarse granularity that is stored in the network (e.g., core network or RAN). The UE may report the static capability with coarse granularity via UE capability reporting procedure. Granularity of the UE capability may be per UE, per band, per band per band combination, per feature set, per features per component carrier (CC). In some examples, the UE does not need to report multiple Feature Set per band Per Component Carrier (FSPC) instance per feature set (FS), and only report 1 and assume each CC has the same FSPC. In some examples, the UE may only report per UE, per band, per band per BC in Static capability. In some examples, only the minimum UE capability is considered in the 1st level UE capability.

In some embodiments, for a two-level UE capability report, the second level UE capability may be reported after RRC Setup procedure, and based on current RRC Configuration and optionally based on capability filter in the RRC dedicated signaling. When the network provides the configuration to UE, and optionally provides the capability filter to help UE generate the reported finer granularity UE capability (e.g., condition, band list). The UE can report capability to network via response message (e.g., ReconfigurationComplete). In addition, the L1/L2 control related capability can be reported via RRC or L1/L2 signaling, which may not impact RRC configuration (e.g., DCI based BWP switch).

In some instances, a capability change may be performed. For example, the UE may dynamically report the changed capability and related condition or changed reason to network.

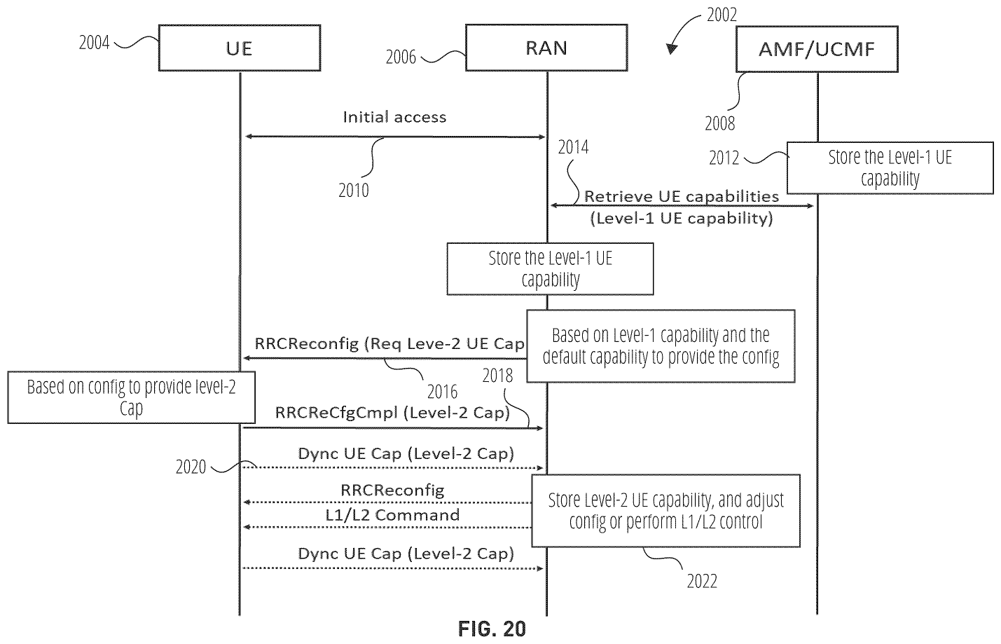

FIG. 20 illustrates a signal flow diagram 2002 for a two-step UE capability report (e.g., level-1 capability and level-2 capability), according to embodiments herein. The UE 2004 and RAN 2006 may perform initial access procedure 2010. The core network 2008 can store 2012 the level-1 UE capability.

In some embodiments, the RAN acquires level-1 capability from the core network 2008. For example, the RAN 2006 may retrieve Level-1 UE capabilities 2014 from the core network 2008. The RAN 2006, based on the level-1 capability, may provide an RRC Configuration 2016 to UE 2004, and requests the UE to provide the level-2 capability. As shown, the RRC configuration 2016 may include a request for level-2 capability. Note that the default set of level-2 capability can be predefined (e.g., predefined in the 3GPP specification).

The UE 2004 may report the level-2 capability based on current configuration. In some cases, the level-2 capability report may be carried in ReconfigComplete message 2018. In some cases, the level-2 capability report 2020 may be carried in new level-2 capability report message.

The RAN 2006 may store 2022 the level-2 capability and the RAN 2006 can perform actions based on level-2 capability. In some embodiments, the RAN 2006 may not forward the level-2 capability to the core network 2008. The actions may include, for example, adjusting the RRC configuration and/or performing the L1/L2 control. In some embodiments, the UE 2004 can report the level-2 capability change via RRC by itself.

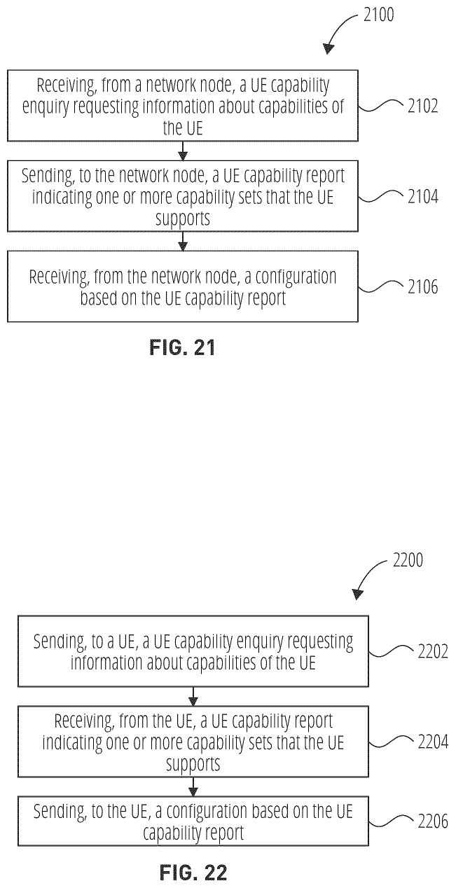

FIG. 21 illustrates a method 2100 performed by a UE, according to embodiments herein. The illustrated method 2100 includes receiving 2102, from a network node, a UE capability enquiry requesting information about capabilities of the UE. The method 2100 further includes sending 2104, to the network node, a UE capability report indicating one or more capability sets that the UE supports. The method 2100 further includes receiving 2106, from the network node, a configuration based on the UE capability report.

In some embodiments of the method 2100, the UE capability report comprises a UE category indicator, wherein the UE category indicator indicates a UE device type and a class of the UE that are associated with a capability set. In some such embodiments, the UE capability report further comprises additional UE category indicators each indicating a different capability set that the UE supports.

In some embodiments of the method 2100, the one or more capability sets in the UE capability report comprises multiple capability sets.

In some embodiments of the method 2100, the one or more capability sets are grouped in at least one of a feature level, a device level, or a condition level. In some such embodiments, the UE capability enquiry indicates a request for a capability set in one specific feature level, device level, or condition level, and wherein the UE capability report includes a first capability set associated with the one specific feature level, device level, or condition level.

In some embodiments, the method 2100 further comprises receiving a reconfiguration message from the network node based on a current condition, wherein the network node stores multiple capability sets for the UE, and wherein each of the multiple capability sets are associated with a condition.

In some embodiments, the method 2100 further comprises determining a current configuration, sending a UE capability change based on the current configuration, and receiving a reconfiguration message from the network node based on the UE capability change.

In some embodiments of the method 2100, sending the UE capability report comprises sending a first capability set with coarse granularity, and sending a second capability set with finer granularity based on a current configuration.

Embodiments contemplated herein include an apparatus comprising means to perform one or more elements of the method 2100. This apparatus may be, for example, an apparatus of a UE (such as a wireless device 2402 that is a UE, as described herein).

Embodiments contemplated herein include one or more non-transitory computer-readable media comprising instructions to cause an electronic device, upon execution of the instructions by one or more processors of the electronic device, to perform one or more elements of the method 2100. This non-transitory computer-readable media may be, for example, a memory of a UE (such as a memory 2406 of a wireless device 2402 that is a UE, as described herein).

Embodiments contemplated herein include an apparatus comprising logic, modules, or circuitry to perform one or more elements of the method 2100. This apparatus may be, for example, an apparatus of a UE (such as a wireless device 2402 that is a UE, as described herein).

Embodiments contemplated herein include an apparatus comprising: one or more processors and one or more computer-readable media comprising instructions that, when executed by the one or more processors, cause the one or more processors to perform one or more elements of the method 2100. This apparatus may be, for example, an apparatus of a UE (such as a wireless device 2402 that is a UE, as described herein).

Embodiments contemplated herein include a signal as described in or related to one or more elements of the method 2100.

Embodiments contemplated herein include a computer program or computer program product comprising instructions, wherein execution of the program by a processor is to cause the processor to carry out one or more elements of the method 2100. The processor may be a processor of a UE (such as a processor(s) 2404 of a wireless device 2402 that is a UE, as described herein). These instructions may be, for example, located in the processor and/or on a memory of the UE (such as a memory 2406 of a wireless device 2402 that is a UE, as described herein).

FIG. 22 illustrates a method 2200 performed by a network node, according to embodiments herein. The illustrated method 2200 includes sending 2202, to a UE, a UE capability enquiry requesting information about capabilities of the UE. The method 2200 further includes receiving 2204, from the UE, a UE capability report indicating one or more capability sets that the UE supports. The method 2200 further includes sending 2206, to the UE, a configuration based on the UE capability report.

In some embodiments of the method 2200, the UE capability report comprises a UE category indicator, wherein the UE category indicator indicates a UE device type and a class of the UE that are associated with a capability set. In some such embodiments, the UE capability report further comprises additional UE category indicators each indicating a different capability set that the UE supports.

In some embodiments of the method 2200, the one or more capability sets in the UE capability report comprises multiple capability sets.

In some embodiments of the method 2200, the one or more capability sets are grouped in at least one of a feature level, a device level, or a condition level. In some such embodiments, the UE capability enquiry indicates a request for a capability set in one specific feature level, device level, or condition level, and wherein the UE capability report includes a first capability set associated with the one specific feature level, device level, or condition level.

In some embodiments, the method 2200 further comprises sending a reconfiguration message based on a current condition, wherein the network node stores multiple capability sets for the UE, and wherein each of the multiple capability sets are associated with a condition.

In some embodiments, the method 2200 further comprises receiving, from the UE, a UE capability change based on the current configuration, and sending a reconfiguration message from the network node based on the UE capability change.

In some embodiments of the method 2200, receiving the UE capability report comprises receiving a first capability set with coarse granularity, and receiving a second capability set with finer granularity based on a current configuration.

Embodiments contemplated herein include an apparatus comprising means to perform one or more elements of the method 2200. This apparatus may be, for example, an apparatus of a base station (such as a network device 2418 that is a base station, as described herein).

Embodiments contemplated herein include one or more non-transitory computer-readable media comprising instructions to cause an electronic device, upon execution of the instructions by one or more processors of the electronic device, to perform one or more elements of the method 2200. This non-transitory computer-readable media may be, for example, a memory of a base station (such as a memory 2422 of a network device 2418 that is a base station, as described herein).

Embodiments contemplated herein include an apparatus comprising logic, modules, or circuitry to perform one or more elements of the method 2200. This apparatus may be, for example, an apparatus of a base station (such as a network device 2418 that is a base station, as described herein).

Embodiments contemplated herein include an apparatus comprising: one or more processors and one or more computer-readable media comprising instructions that, when executed by the one or more processors, cause the one or more processors to perform one or more elements of the method 2200. This apparatus may be, for example, an apparatus of a base station (such as a network device 2418 that is a base station, as described herein).

Embodiments contemplated herein include a signal as described in or related to one or more elements of the method 2200.

Embodiments contemplated herein include a computer program or computer program product comprising instructions, wherein execution of the program by a processing element is to cause the processing element to carry out one or more elements of the method 2200. The processor may be a processor of a base station (such as a processor(s) 2420 of a network device 2418 that is a base station, as described herein). These instructions may be, for example, located in the processor and/or on a memory of the base station (such as a memory 2422 of a network device 2418 that is a base station, as described herein).

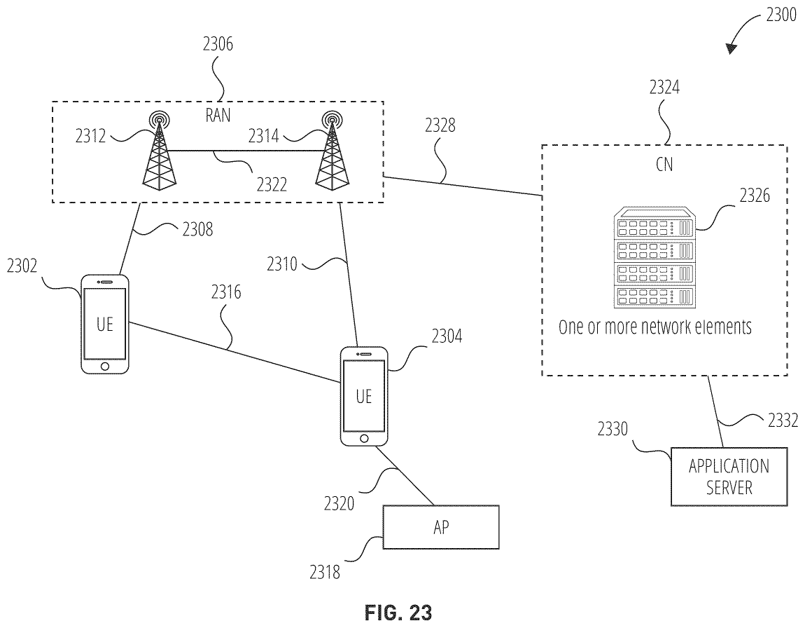

FIG. 23 illustrates an example architecture of a wireless communication system 2300, according to embodiments disclosed herein. The following description is provided for an example wireless communication system 2300 that operates in conjunction with the LTE system standards and/or 5G or NR system standards as provided by 3GPP technical specifications.

As shown by FIG. 23, the wireless communication system 2300 includes UE 2302 and UE 2304 (although any number of UEs may be used). In this example, the UE 2302 and the UE 2304 are illustrated as smartphones (e.g., handheld touchscreen mobile computing devices connectable to one or more cellular networks), but may also comprise any mobile or non-mobile computing device configured for wireless communication.

The UE 2302 and UE 2304 may be configured to communicatively couple with a RAN 2306. In embodiments, the RAN 2306 may be NG-RAN, E-UTRAN, etc. The UE 2302 and UE 2304 utilize connections (or channels) (shown as connection 2308 and connection 2310, respectively) with the RAN 2306, each of which comprises a physical communications interface. The RAN 2306 can include one or more base stations (such as base station 2312 and base station 2314) that enable the connection 2308 and connection 2310.

In this example, the connection 2308 and connection 2310 are air interfaces to enable such communicative coupling, and may be consistent with RAT(s) used by the RAN 2306, such as, for example, an LTE and/or NR.

In some embodiments, the UE 2302 and UE 2304 may also directly exchange communication data via a sidelink interface 2316. The UE 2304 is shown to be configured to access an access point (shown as AP 2318) via connection 2320. By way of example, the connection 2320 can comprise a local wireless connection, such as a connection consistent with any IEEE 802.11 protocol, wherein the AP 2318 may comprise a Wi-Fi® router. In this example, the AP 2318 may be connected to another network (for example, the Internet) without going through a CN 2324.

In embodiments, the UE 2302 and UE 2304 can be configured to communicate using orthogonal frequency division multiplexing (OFDM) communication signals with each other or with the base station 2312 and/or the base station 2314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2312 or base station 2314 may be implemented as one or more software entities running on server computers as part of a virtual network. In addition, or in other embodiments, the base station 2312 or base station 2314 may be configured to communicate with one another via interface 2322. In embodiments where the wireless communication system 2300 is an LTE system (e.g., when the CN 2324 is an EPC), the interface 2322 may be an X2 interface. The X2 interface may be defined between two or more base stations (e.g., two or more eNBs and the like) that connect to an EPC, and/or between two eNBs connecting to the EPC. In embodiments where the wireless communication system 2300 is an NR system (e.g., when CN 2324 is a 5GC), the interface 2322 may be an Xn interface. The Xn interface is defined between two or more base stations (e.g., two or more gNBs and the like) that connect to 5GC, between a base station 2312 (e.g., a gNB) connecting to 5GC and an eNB, and/or between two eNBs connecting to 5GC (e.g., CN 2324).

The RAN 2306 is shown to be communicatively coupled to the CN 2324. The CN 2324 may comprise one or more network elements 2326, which are configured to offer various data and telecommunications services to customers/subscribers (e.g., users of UE 2302 and UE 2304) who are connected to the CN 2324 via the RAN 2306. The components of the CN 2324 may be implemented in one physical device or separate physical devices including components to read and execute instructions from a machine-readable or computer-readable medium (e.g., a non-transitory machine-readable storage medium).

In embodiments, the CN 2324 may be an EPC, and the RAN 2306 may be connected with the CN 2324 via an S1 interface 2328. In embodiments, the S1 interface 2328 may be split into two parts, an S1 user plane (S1-U) interface, which carries traffic data between the base station 2312 or base station 2314 and a serving gateway (S-GW), and the S1-MME interface, which is a signaling interface between the base station 2312 or base station 2314 and mobility management entities (MMEs).

In embodiments, the CN 2324 may be a 5GC, and the RAN 2306 may be connected with the CN 2324 via an NG interface 2328. In embodiments, the NG interface 2328 may be split into two parts, an NG user plane (NG-U) interface, which carries traffic data between the base station 2312 or base station 2314 and a user plane function (UPF), and the S1 control plane (NG-C) interface, which is a signaling interface between the base station 2312 or base station 2314 and access and mobility management functions (AMFs).

Generally, an application server 2330 may be an element offering applications that use internet protocol (IP) bearer resources with the CN 2324 (e.g., packet switched data services). The application server 2330 can also be configured to support one or more communication services (e.g., VOIP sessions, group communication sessions, etc.) for the UE 2302 and UE 2304 via the CN 2324. The application server 2330 may communicate with the CN 2324 through an IP communications interface 2332.

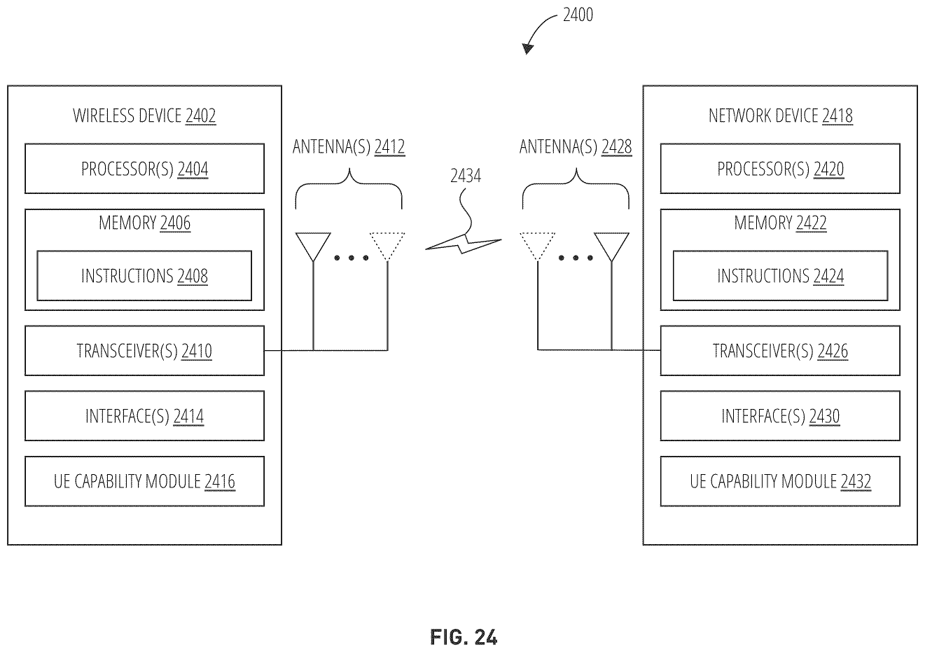

FIG. 24 illustrates a system 2400 for performing signaling 2434 between a wireless device 2402 and a network device 2418, according to embodiments disclosed herein. The system 2400 may be a portion of a wireless communications system as herein described. The wireless device 2402 may be, for example, a UE of a wireless communication system. The network device 2418 may be, for example, a base station (e.g., an eNB or a gNB) of a wireless communication system.

The wireless device 2402 may include one or more processor(s) 2404. The processor(s) 2404 may execute instructions such that various operations of the wireless device 2402 are performed, as described herein. The processor(s) 2404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2402 may include a memory 2406. The memory 2406 may be a non-transitory computer-readable storage medium that stores instructions 2408 (which may include, for example, the instructions being executed by the processor(s) 2404). The instructions 2408 may also be referred to as program code or a computer program. The memory 2406 may also store data used by, and results computed by, the processor(s) 2404.

The wireless device 2402 may include one or more transceiver(s) 2410 that may include radio frequency (RF) transmitter circuitry and/or receiver circuitry that use the antenna(s) 2412 of the wireless device 2402 to facilitate signaling (e.g., the signaling 2434) to and/or from the wireless device 2402 with other devices (e.g., the network device 2418) according to corresponding RATs.

The wireless device 2402 may include one or more antenna(s) 2412 (e.g., one, two, four, or more). For embodiments with multiple antenna(s) 2412, the wireless device 2402 may leverage the spatial diversity of such multiple antenna(s) 2412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2402 may be accomplished according to precoding (or digital beamforming) that is applied at the wireless device 2402 that multiplexes the data streams across the antenna(s) 2412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2402 may implement analog beamforming techniques, whereby phases of the signals sent by the antenna(s) 2412 are relatively adjusted such that the (joint) transmission of the antenna(s) 2412 can be directed (this is sometimes referred to as beam steering).

The wireless device 2402 may include one or more interface(s) 2414. The interface(s) 2414 may be used to provide input to or output from the wireless device 2402. For example, a wireless device 2402 that is a UE may include interface(s) 2414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2410/antenna(s) 2412 already described) that allow for communication between the UE and other devices and may operate according to known protocols (e.g., Wi-Fi®, Bluetooth®, and the like).

The wireless device 2402 may include a UE capability module 2416. The UE capability module 2416 may be implemented via hardware, software, or combinations thereof. For example, the UE capability module 2416 may be implemented as a processor, circuit, and/or instructions 2408 stored in the memory 2406 and executed by the processor(s) 2404. In some examples, the UE capability module 2416 may be integrated within the processor(s) 2404 and/or the transceiver(s) 2410. For example, the UE capability module 2416 may be implemented by a combination of software components (e.g., executed by a DSP or a general processor) and hardware components (e.g., logic gates and circuitry) within the processor(s) 2404 or the transceiver(s) 2410.

The UE capability module 2416 may be used for various aspects of the present disclosure. For example, the UE capability module 2416 may be configured to perform any of the UE-based methods discussed herein.

The network device 2418 may include one or more processor(s) 2420. The processor(s) 2420 may execute instructions such that various operations of the network device 2418 are performed, as described herein. The processor(s) 2420 may include one or more baseband processors implemented using, for example, a CPU, a DSP, an ASIC, a controller, an FPGA device, another hardware device, a firmware device, or any combination thereof configured to perform the operations described herein.

The network device 2418 may include a memory 2422. The memory 2422 may be a non-transitory computer-readable storage medium that stores instructions 2424 (which may include, for example, the instructions being executed by the processor(s) 2420). The instructions 2424 may also be referred to as program code or a computer program. The memory 2422 may also store data used by, and results computed by, the processor(s) 2420.

The network device 2418 may include one or more transceiver(s) 2426 that may include RF transmitter circuitry and/or receiver circuitry that use the antenna(s) 2428 of the network device 2418 to facilitate signaling (e.g., the signaling 2434) to and/or from the network device 2418 with other devices (e.g., the wireless device 2402) according to corresponding RATs.

The network device 2418 may include one or more antenna(s) 2428 (e.g., one, two, four, or more). In embodiments having multiple antenna(s) 2428, the network device 2418 may perform MIMO, digital beamforming, analog beamforming, beam steering, etc., as has been described.

The network device 2418 may include one or more interface(s) 2430. The interface(s) 2430 may be used to provide input to or output from the network device 2418. For example, a network device 2418 that is a base station may include interface(s) 2430 made up of transmitters, receivers, and other circuitry (e.g., other than the transceiver(s) 2426/antenna(s) 2428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2418 may include a UE capability module 2432. The UE capability module 2432 may be implemented via hardware, software, or combinations thereof. For example, the UE capability module 2432 may be implemented as a processor, circuit, and/or instructions 2424 stored in the memory 2422 and executed by the processor(s) 2420. In some examples, the UE capability module 2432 may be integrated within the processor(s) 2420 and/or the transceiver(s) 2426. For example, the UE capability module 2432 may be implemented by a combination of software components (e.g., executed by a DSP or a general processor) and hardware components (e.g., logic gates and circuitry) within the processor(s) 2420 or the transceiver(s) 2426.

The UE capability module 2432 may be used for various aspects of the present disclosure. For example, the UE capability module 2432 may be configured to perform any of the network-based methods discussed herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, net work element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a user equipment (UE), the method comprising:
receiving, from a network node, a UE capability enquiry requesting information about capabilities of the UE;
sending, to the network node, a UE capability report indicating one or more capability sets that the UE supports; and
receiving, from the network node, a configuration based on the UE capability report.

2. The method of claim 1, wherein the UE capability report comprises a UE category indicator, wherein the UE category indicator indicates a UE device type and a class of the UE that are associated with a capability set.

3. The method of claim 2, wherein the UE capability report further comprises additional UE category indicators each indicating a different capability set that the UE supports.

4. The method of claim 1, wherein the one or more capability sets in the UE capability report comprises multiple capability sets.

5. The method of claim 1, wherein the one or more capability sets are grouped in at least one of a feature level, a device level, or a condition level.

6. The method of claim 5, wherein the UE capability enquiry indicates a request for a capability set in one specific feature level, device level, or condition level, and
wherein the UE capability report includes a first capability set associated with the one specific feature level, device level, or condition level.

7. The method of claim 1, the method further comprising receiving a reconfiguration message from the network node based on a current condition, wherein the network node stores multiple capability sets for the UE, and wherein each of the multiple capability sets are associated with a condition.

8. The method of claim 1, further comprising:
determining a current configuration;
sending a UE capability change based on the current configuration; and
receiving a reconfiguration message from the network node based on the UE capability change.

9. The method of claim 1, wherein sending the UE capability report comprises sending a first capability set with coarse granularity, and sending a second capability set with finer granularity based on a current configuration.

10. A method performed by a network node, the method comprising:
sending, to a user equipment (UE), a UE capability enquiry requesting information about capabilities of the UE;
receiving, from the UE, a UE capability report indicating one or more capability sets that the UE supports; and
sending, to the UE, a configuration based on the UE capability report.

11. The method of claim 10, wherein the UE capability report comprises a UE category indicator, wherein the UE category indicator indicates a UE device type and a class of the UE that are associated with a capability set.

12. The method of claim 11, wherein the UE capability report further comprises additional UE category indicators each indicating a different capability set that the UE supports.

13. The method of claim 10, wherein the one or more capability sets in the UE capability report comprises multiple capability sets.

14. The method of claim 10, wherein the one or more capability sets are grouped in at least one of a feature level, a device level, or a condition level.

15. The method of claim 14, wherein the UE capability enquiry indicates a request for a capability set in one specific feature level, device level, or condition level, and
wherein the UE capability report includes a first capability set associated with the one specific feature level, device level, or condition level.

16. The method of claim 10, the method further comprising sending a reconfiguration message based on a current condition, wherein the network node stores multiple capability sets for the UE, and wherein each of the multiple capability sets are associated with a condition.

17. The method of claim 10, further comprising:
receiving, from the UE, a UE capability change based on the current configuration; and
sending a reconfiguration message from the network node based on the UE capability change.

18. The method of claim 10, wherein receiving the UE capability report comprises receiving a first capability set with coarse granularity, and receiving a second capability set with finer granularity based on a current configuration.

19. A user equipment (UE) apparatus comprising:
a processor; and
a memory storing instructions that, when executed by the processor, configure the UE apparatus to:
receive, from a network node, a UE capability enquiry requesting information about capabilities of the UE;
send, to the network node, a UE capability report indicating one or more capability sets that the UE supports; and
receive, from the network node, a configuration based on the UE capability report.

20. The UE apparatus of claim 19, wherein the UE capability report comprises a UE category indicator, wherein the UE category indicator indicates a UE device type and a class of the UE that are associated with a capability set.
